(19) United States
(12) Patent Application Publication
(10) Pub. No.: US 2024/0059591 A1
(43) Pub. Date: Feb. 22, 2024

(54) SYSTEM AND METHODS FOR CONDENSING VAPOR PRODUCT

(71) Applicant: Breakthrough Technologies, LLC, Boston, MA (US)

(72) Inventor: Kamal Jaffrey, Winchester, MA (US)

(21) Appl. No.: 18/270,670

(22) PCT Filed: Dec. 30, 2021
(86) PCT No.: PCT/US2021/065745

§ 371 Date: Jun. 30, 2023

Related U.S. Application Data
(60) Provisional application No. 63/209,630, filed on Jun. 11, 2021.
(60) Provisional application No. 63/132,037, filed on Dec. 30, 2020.

(51) Int. Cl. C02F 1/46; B01D 5/00; B01D 53/32; B01D 1/00; B01D 1/30; C02F 1/461; C02F 1/04

(52) U.S. Cl. CPC C02F 1/4608; B01D 5/0015; B01D 5/0042; B01D 53/32; B01D 1/0017; B01D 1/305; C02F 1/46109; C02F 1/048; B01D 5/0057; B01D 5/009; B01D 2259/818; C02F 2001/46152; C02F 2103/023

(57) ABSTRACT

A system for condensing vapor product is provided. The system includes a first duct configured to receive a vapor product having a first humidity level, the first duct having a first charge in response to application of a first voltage to the first duct so as to ionize the vapor product. A second duct is configured to allow the ionized vapor product to pass therethrough and configured with a second charge in response to application of a second volt age to thereby allow collection of at least a portion of liquid particles present in the ionized vapor product and form a first modified vapor product. A chamber is configured to receive the first modified vapor product and includes at least one cooling plate configured to reduce a temperature of the first modified vapor product, and at least one first mesh plate configured to collect at least a portion of liquid particles. Methods for condensing vapor are also provided.

### CROSS-REFERENCE TO RELATED APPLICATIONS

This application claims priority to U.S. Provisional Application No. 63/132,037, filed Dec. 30, 2020, and U.S. Provisional Application No. 63/209,630, filed Jun. 11, 2021, the disclosures of all of which are incorporated herein by reference in their entirety.

### TECHNICAL FIELD

The current subject matter is generally related to systems and methods for condensing vapor product, for example, water vapor condensing systems.

### BACKGROUND

Scavenging water can be a sustainable solution to water scarcity problems in many regions around the world. Desalination is a form of purifying liquid, especially water, and refers to a process that removes some amount of salt and other minerals from saline water. Via desalination, salt water can be converted to fresh water suitable for human consumption, irrigation, or other uses. Due to relatively high-energy consumption, the costs of desalinating seawater are generally higher than the alternatives (e.g., fresh water from rivers or groundwater, water recycling, water conservation, and the like), but alternatives are not always available. Reverse osmosis is another process for purifying water. However, reverse osmosis uses expensive membranes and high-pressures, which requires significant energy.

### SUMMARY

An embodiment of the present disclosure provides a system for condensing vapor product. The system includes a first duct configured to receive a vapor product having a first humidity level, the first duct having a first charge in response to application of a first voltage to the first duct so as to ionize the vapor product. A second duct is in fluid communication with and arranged downstream of the first duct and configured to allow the ionized vapor product to pass therethrough. The second duct is configured with a second charge in response to application of a second voltage that is different than the first voltage to thereby allow collection of at least a portion of liquid particles present in the ionized vapor product and form a first modified vapor product with a first modified humidity level that is greater than the first humidity level. A chamber is configured to receive the first modified vapor product includes at least on cooling plate and at least one first mesh plate. The at least one cooling plate is configured to reduce a temperature of the first modified vapor product to form a second modified vapor product having a second modified humidity level that is less than the first modified humidity level. The at least one first mesh plate is arranged downstream of the at least one cooling plate and configured to collect at least a portion of liquid particles present within the second modified vapor product or a third modified vapor product to form a fourth modified vapor product having a fourth modified humidity level that is less than at least the second modified humidity level. The at least one first mesh plate has a third charge in response to application of a third voltage that is different than the second voltage.

In some embodiments, the system can further include a separator. The separator can be configured to direct liquid particles from at least the first modified vapor product and into a reservoir. In other embodiments, the separator can include a conical-shaped plate arranged within the chamber such that a gap is formed between the conical-shaped plate and a sidewall of the chamber, where the gap is configured to receive and direct the liquid particles into the reservoir.

The chamber can have a variety of configurations. In some embodiments, the chamber can further include a point electrode having a fourth charge in response to application of a fourth voltage that is different than the third voltage. In other embodiments, the point electrode can be configured to ionize the second modified vapor product that passes across or proximate to the point electrode to modify the electrical charge of the second modified vapor product.

The second duct can have a variety of configurations. In some embodiments, the second duct can include a spiral electrode at least partially extending through a channel of the second duct, the spiral electrode being electrically charged with the second voltage. In other embodiments, the spiral electrode can include a plurality of point electrodes arranged along a length of the spiral electrode.

In some embodiments, the at least one cooling plate can include a thermoelectric cooler.

In some embodiments, the chamber can further include at least one second mesh plate positioned between the point electrode and the at least one first mesh plate, the at least one second mesh plate configured to configured to collect at least a portion of liquid particles present within the second modified vapor product to form a third modified vapor product having a third modified humidity level that is less than at least the second modified humidity level.

In some embodiments, the at least one first mesh plate can be further configured to allow the collection of the liquid particles to selectively separate from the at least one first mesh plate by at least gravity.

In some embodiments, the chamber can further include a reservoir configured to receive liquid particles selectively separated from at least the first modified vapor product and the second modified vapor product.

In some embodiments, the system can further include a blower configured to propel the vapor product through the first duct and second duct to the chamber. In other embodiments, the system can further include a reducer positioned between the first duct and the second duct and configured to increase the flow rate of the ionized vapor product as it passes through the reducer and towards the second duct.

In another embodiment, a method of condensing vapor product is provided. The method includes passing a vapor product through a first duct electrically charged with a first voltage to ionize the vapor product. The ionized vapor product passes through a second duct positioned downstream of and in fluid communication with the first duct to form a first modified vapor product, the second duct being electrically charged with a second voltage that is different than the first voltage. The first modified vapor product passes into a chamber, the chamber having at least one cooling plate and at least one first mesh plate positioned downstream of the at least one cooling plate, the at least one first mesh plate being electrically charged with a third voltage that is different than at least the second voltage. At least one cooling plate cools the first modified vapor product to form a second modified vapor product. The at least one first mesh plate removes at least a portion of liquid particles present within the second modified vapor product or a third modified vapor product to form a fourth modified vapor product.

In some embodiments, the vapor product can have a first humidity level, the first modified vapor product has a first modified humidity level that is greater than the first humidity level, the second modified vapor product can have a second modified humidity level that is less than the first humidity level, and the fourth modified vapor product can have a third humidity level that is less than the second modified humidity level.

In some embodiments, the chamber can include a separator positioned between an inlet of the chamber and the at least one cooling plate. In other embodiments, the method can further include, prior to the removing step, separating, by the separator, at least a portion of liquid particles present within the first modified vapor product.

In some embodiments, a point electrode is electrically charged with a fourth voltage that is different than at least the third voltage. In other embodiments, the method can further include ionizing, by the point electrode, the second modified vapor product that passes across or proximate to the point electrode to modify the electrical charge of the second modified vapor product.

In some embodiments, the chamber can include at least one second mesh plate. In other embodiments, the method can further include removing, by the at least one second mesh plate, at least a portion of liquid particles present within the second modified vapor product to form a third modified vapor product having a third modified humidity level that is less than at least the second modified humidity level.

In some embodiments, a reducer can be positioned between the first duct and the second duct. In other embodiments, the method can further include increasing, by the reducer, a flow rate of the ionized vapor product as it passes therethrough and towards the second duct.

In some embodiments, the second duct can include a spiral electrode disposed within the second duct, the spiral electrode being electrically charged with the second voltage. In some embodiments, passing the ionized vapor through a second duct can include passing the ionized vapor product across the spiral electrode to allow at least a portion of liquid particles present within the ionized vapor product to collect on the spiral electrode, wherein the collection of the liquid particles selectively separates from the spiral electrode such that the combination of the collection of liquid particles and the remaining ionized vapor product form the first modified vapor product.

In some embodiments, the method can further include collecting the liquid particles selectively separated from at least the from at least the first modified vapor product and the second modified vapor product and transferring the collected liquid particles to a reservoir.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

FIG. 1 is a schematic view of a system for condensing vapor according to an exemplary embodiment of the present disclosure;

FIG. 2 is a schematic view of a system for condensing aerosol in a cooling tower according to an exemplary embodiment of the present disclosure;

FIG. 3 illustrates a source mesh and a condensing mesh according to an exemplary embodiment of the present disclosure;

FIG. 4 is a schematic view of a condenser used in a system for condensing aerosol according to an exemplary embodiment of the present disclosure;

FIG. 5A is a flow chart for a method for condensing aerosol according to an exemplary embodiment of the present disclosure;

FIG. 5B is a flow chart for a method for condensing aerosol according to another exemplary embodiment of the present disclosure;

FIG. 6 is a schematic view of a system for humidity control according to an exemplary embodiment of the present disclosure;

FIG. 7 is a schematic view of a system for humidity control according to another exemplary embodiment of the present disclosure;

FIG. 8A illustrates an arrangement of the source electrode and the sink electrode according to an exemplary embodiment of the present disclosure;

FIG. 8B illustrates an arrangement of the source electrode and the sink electrode according to another exemplary embodiment of the present disclosure;

FIG. 9A is a schematic view of a system for condensing aerosol in a cooling tower according to an exemplary embodiment of the present disclosure:

FIG. 9B is a schematic view of the duct with a converging-diverging portion and a wind turbine disposed within the converging-diverging portion according to an exemplary embodiment of the present disclosure;

FIG. 9C is a schematic view of the duct with a converging portion and a wind turbine disposed within the converging portion according to an exemplary embodiment of the present disclosure;

FIG. 9D is a schematic view of the duct with a diverging-converging portion and a wind turbine disposed within the diverging-converging portion according to an exemplary embodiment of the present disclosure;

FIG. 10 is a schematic view of a cooling tower monitoring system (CTMS) according to an exemplary embodiment of the present disclosure;

FIG. 11 lists elements of the CTMS according to an exemplary embodiment of the present disclosure;

FIG. 12 illustrates sensor and control elements of the CTMS according to an exemplary embodiment of the present disclosure;

FIG. 13 is diagram illustrating a system for reducing thermal, chemical, and biological pollution according to an exemplary embodiment of the present disclosure;

FIG. 14A is a side view of another example embodiment of a condensing system according to some aspects of the current subject matter;

FIG. 14B is a schematic view of a duct of the condensing system of FIG. 14A;

FIG. 14C is a schematic view of a condensing chamber of the condensing system of FIG. 14A;

FIG. 14D is a schematic view of a thermoelectric cooling (TEC) unit of the condensing system of FIG. 14A;

FIG. 15 is a partial perspective view of the condensing chambers of the condensing system of FIG. 14A:

FIG. 16 is a partial perspective view of the condensing chambers of the condensing system of FIG. 14A;

FIG. 17 is a side view of an example embodiment of a condensing system according to some aspects of the current subject matter:

FIG. 18A is a top view of the condensing system of FIG. 17;

FIG. 18B is a perspective view of the condensing system of FIG. 17;

FIG. 19 is an arrow volume plot illustrating velocity fields within the condensing system of FIG. 17;

FIG. 20 is a contour plot illustrating velocity magnitudes within the condensing system of FIG. 17;

FIG. 21 is a contour plot illustrating pressure within the condensing system of FIG. 17;

FIG. 22 is a streamline plot illustrating velocity fields within the condensing system of FIG. 17;

FIG. 23 is a slice plot illustrating velocity magnitude within the condensing system of FIG. 17;

FIG. 24 is a surface plot illustrating wall resolution in viscous units within the condensing system of FIG. 17;

FIG. 25 is a plot illustrating particle trajectories within the condensing system of FIG. 17;

FIG. 26 is a perspective view of a system for reducing evaporative waste and pollution according to an exemplary embodiment of the present disclosure:

FIG. 27 is an exploded view of the system of FIG. 26;

FIG. 28 is a perspective view of an example embodiment of a cooling tower of the system of FIG. 26;

FIG. 29 is a schematic view of the cooling tower of FIG. 28;

FIG. 30 is a schematic view of the system of FIG. 26 illustrating a condensing process within an upper duct;

FIG. 31 is a schematic view of the system of FIG. 26 illustrating a condensing process within a condensing chamber,

FIG. 32 is a schematic view of the system of FIG. 26 illustrating a condensing process within the condensing chamber of FIG. 31; and

FIG. 33 is a schematic view of the system of FIG. 26 illustrating a condensing process within the cooling tower of FIG. 28.

### DETAILED DESCRIPTION

The current subject matter can provide a safe and energy efficient technology to condense and collect water (e.g., in the liquid phase) from one or more aerosols (e.g., a vapor-phase and/or condensed-phase of material (e.g., water) suspended in a stationary or moving mass of air or some other gas carrier) by applying an electrical field between a source electrode and a sink electrode to drive the one or more aerosols along the electrical field. By creating an electrical field and driving the one or more aerosols, without ionizing the one or more aerosols with a high voltage electrical source, the system can be implemented to be safer, have higher efficiency, and produce water with fewer impurities, as compared to some conventional approaches. Exemplary applications include a turbine cooling tower and combustion smoke stack. Existing infrastructures may be retro-fitted and integrated using the current subject matter.

Techniques of scavenging water droplets (e.g., liquid particles of water) from air (e.g., ambient air) can include collectors in the form of wire meshes, and the condensation relies on inertial collision of the water droplets onto the collector meshes for water capture. The use of wire meshes alone can be limited by aerodynamic drag forces since water droplets may be required to collide with the wire meshes.

A problem associated with previous approaches to condensing and collecting water may be solved by utilizing electrical forces. The water (e.g., a vapor-phase and/or liquid-phase of water) in the carrier gas (e.g., air) may be electrically charged and directed toward a collector by an imposed electric field. When the water is electrically charged, it can be attracted to a collector that is charged with an opposite charge. Therefore, the charged water can collide with surfaces of the collector meshes with an increased probability. Upon impact, water droplets can stick to the mesh and coagulate with other incoming water droplets. As a result, when the coagulated water droplets become sufficiently large and heavy on the collector mesh, the water droplets may precipitate due to gravity (e.g., separate from the collector mesh), and the precipitating water droplets may be collected in a reservoir.

There may be a number of different means to scavenge water (e.g., in the liquid-phase) from one or more aerosols. In some conventional approaches that utilize electrical forces for collecting water, corona discharge may be used to introduce a space charge into the water to impart a net charge to the incoming water droplets. Corona discharge may be produced by using a sharp metallic needle that is connected to a high-voltage generator. Typically, voltages to produce stable corona discharge ranges from −10 kV to −24 kV.

However, using corona discharge to impart electrical charges to water may present problems. For example, corona discharge ionizes surrounding air, and can produce gases such as ozone (O₃) and nitric oxide (NO). Nitric oxide can be further oxidized to form nitrogen dioxide (NO₂) and subsequently nitric acid (HNO₃) through photochemical reactions. These gases and liquids are toxic, corrosive, and environmentally harmful. If the water vapor condensing system includes the corona discharge system, what is collected at the collector is corrosive and toxic acid. As a result, the collected liquid requires further treatment if it is desired to be used for useful purposes. In addition, the corona discharge system, when implemented for water vapor condensing system, may be dangerous due to the high voltage associated therewith, may waste large amount of energy, and/or may interfere neighboring electronic instruments due to the high voltage discharges. Moreover, the corona discharge system poses a concern for explosion when the system is surrounded by debris with high surface areas (e.g., dust particles) and/or loose articles.

In some implementations, an electric field may be applied within a predefined space to direct and collect the water (e.g., liquid particles of water) from one or more aerosols. In a system using the electric field to scavenge water (e.g., liquid particles of water) from one or more aerosols, the system may not require a high voltage generator, and thus, the surrounding air may not be ionized. Since the dielectric breakdown voltage of air is relatively high, at about 3 kV/mm, a substantial electric field may be applied within the predefined space to drive the one or more aerosols to a particular location (e.g., a sink electrode) where the water present within the one or more aerosols may be coagulated and collected. Consequently, toxic and corrosive gases and liquids are not produced. The system can be implemented to be safer than the corona discharge system, has better energy utilization efficiency, and moreover, produces water with fewer impurities to allow the collected water to be directly used (e.g., without further processing or purification). Since the system relies on the polar nature of water molecules, the system may discriminate polar aerosols (e.g., water) from non-polar aerosols (e.g., dust), and thereby producing condensed water with fewer impurities.

In some implementations, a further benefit of the current subject matter can include pollution reduction. Industrial cooling equipment which can emit aerosolized vapor containing chemical and/or biological pollutants. For example, a cooling tower may emit particulate matter, volatile organic compounds, and other toxic air contaminants as a result of dissolved solids in the cooling tower circulation water. These pollutants can become entrained in the air and/or water (e.g., water in the gas-phase or liquid-phase) that is discharged from the cooling tower. In some embodiments, the air and/or water emitted from the cooling tower can also include thermal pollutants. For example, the air and/or water emitted from a cooling tower can be emitted at a higher temperature compared to the temperature of the environment in which the cooling tower is located. Elevated temperature emissions can negatively impact the localized environment by altering the thermodynamic conditions of the environment. For example, the elevated temperature emissions can act as a catalyst for chemical and biological pollutants which may also be present in the environment or which were previously existing in the environment and can cause the chemical and biological pollutants to increase in concentration, reaction kinetics, likelihood of dispersion, or the like.

Some implementations of the systems described herein can mitigate thermal, chemical, and/or biological pollution by scavenging water from the emitted one or more aerosols from the cooling tower and maintaining the scavenged water within a closed-loop system coupled to the aerosol emission source. Chemical and biological pollutants can be removed from the emitted aerosols using the system described herein causing these types of pollutants to be retained within the cooling tower circulation system and not emitted into the ambient environment. In addition, some implementations of the systems described herein can reduce thermal pollution by directing high temperature aerosol emissions into the cooling tower circulation, thereby utilizing the thermal mass of the water or cooling medium circulating within the cooling tower system to reduce elevated temperatures of emitted aerosols.

As the world's population continues to rise, and climate change reduces water availability, water scarcity has become one of the most critical issues of our time. Around the world, industrial cooling towers, which use water to extract heat created during manufacturing processes, require a significant amount of water. It is estimated that there are as many at two million cooling towers in the United States alone. A mid-sized tower can lose up to one hundred million gallons of water each year. Traditional cooling towers use water to extract waste heat and eject it into the atmosphere. In these towers humid air carries warm water vapor out of the tower, which is called a plume. Many cooling towers also utilize a sump or basin that collects water and impurities that over time lead to corrosion and bacteria growth. These issues are often controlled by adding water and expensive chemicals.

It is beneficial to have a system which can recover up to about 90% of water loss during cooling tower operations, which can improve the operating condition, optimize process indicators, reduce corrosion of the equipment, extend equipment life, increase the amount of processing and recovery of valuable materials, protect the environment, and decrease air pollution.

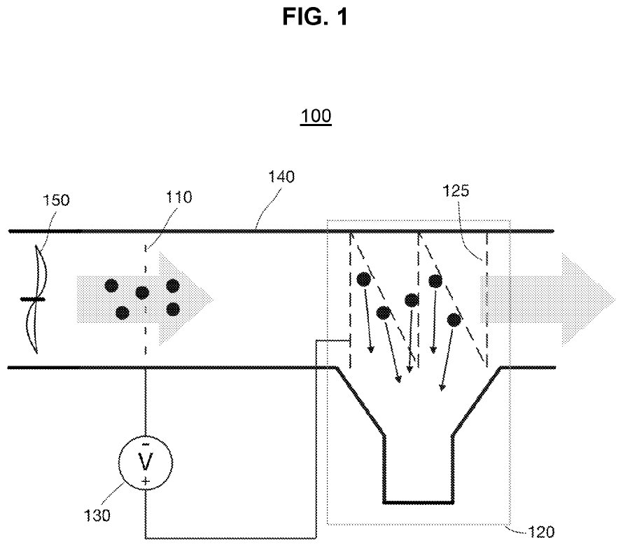

FIG. 1 is a schematic view of a system 100 for condensing vapor according to an exemplary embodiment of the present disclosure. Referring to FIG. 1, the system 100 for condensing vapor may include a source electrode 110, a condenser 120, and a duct 140. In some implementations, duct 140 can include a plurality of ducts (e.g., 2, 3, 4, 5, or more ducts).

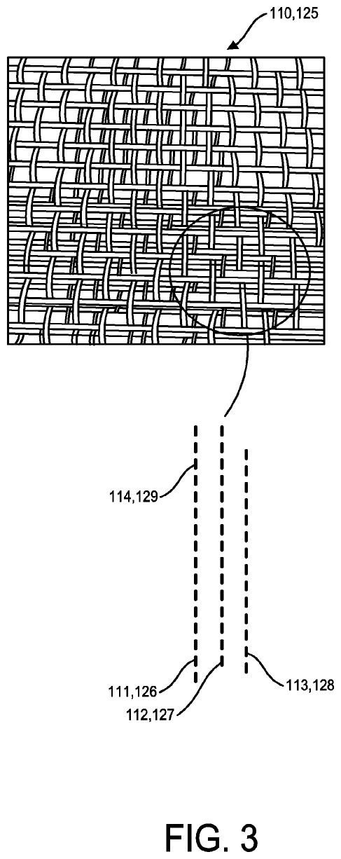

The source electrode 110 may be electrically connected to an electrical source 130 that may apply an electrical voltage to the source electrode 110. The source electrode 110 may apply an electric field within the duct 140 to drive the ambient aerosols that that contained in an incoming air stream. The source electrode 110 may include a source mesh. An example of the source mesh is shown in FIG. 3. Referring to FIG. 3, the source mesh may include a plurality of layers 111, 112 and 113.

Each of the plurality of layers 111, 112 and 113 may have a plurality of openings. Each opening 114 formed in each of the plurality of layers 111, 112 and 113 may have a characteristic dimension between 1 mm to 15 mm, depending on applications, flow rate requirements, applied voltages, and the like. In some implementations, the characteristic dimension of each opening 114 may be the same among the plurality of the openings or may be different. Moreover, the opening 114 of the plurality of layers 111, 112 and 113 may be aligned with each other or may be staggered. The source mesh of the source electrode 110 may be made of a conductive material. Examples of the materials that can be used for the source mesh include stainless steel, nickel, conductive polymers, and conductive silicone. Further, the source mesh may be made of and/or coated with a hydrophobic material to prevent the uptake of water vapor. The source electrode 110 may also be implemented with a liquid or a gas depending on the application and the use environment.

The source mesh may include a network of wires. The network of wires may include a plurality of interlaced or interwoven wires. Each layer of the source mesh may include a plurality of interlaced or interwoven wires that run in a predetermined pattern at substantially regular intervals. In this exemplary implementation of the source mesh, the characteristic dimension of the opening 114 may be defined by the regular intervals of the pattern. Alternatively or additionally, the source mesh may be formed to include randomly woven wires. In this exemplary implementation, the characteristic dimension of the opening 114 may be defined by a maximum diameter of particles that can be passed without being filtered by more than a certain threshold transmission efficiency. For example, the characteristic dimension of the opening 114 may be said to be 1 mm if more than a certain percentage of the 1 mm particles can be transmitted through the source mesh. The threshold transmission efficiency may be set to 90%, but the present disclosure is not limited thereto. The wires that form the source mesh may have a diameter between 0.5 mm and 5 mm depending on applications, flow rate requirements, applied voltages, and the like. Although an example has been described for the wire mesh that includes horizontal wires and vertical wires, the present disclosure is not limited thereto. The source mesh may consist merely of horizontal wires or vertical wires.

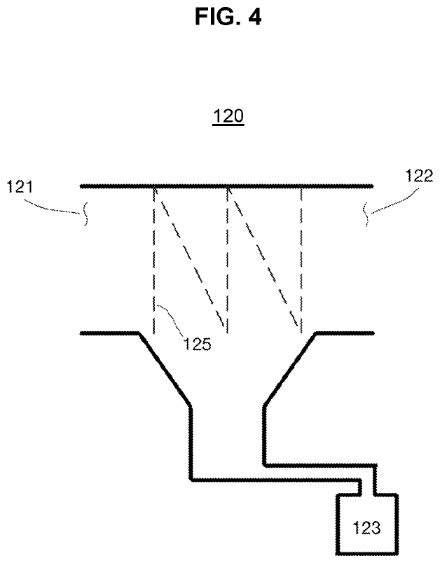

The water vapor may be attracted to and collected at the condenser 120. As shown in FIG. 4, the condenser 120 may include an inlet 121, an outlet 122, and a reservoir 123. In operation, the inlet 121 may receive an incoming air stream having a first relative humidity value. The outlet 122 may discharge an outgoing air stream having a second relative humidity value. To achieve a net condensing of water vapor, the second relative humidity may be lower than the first relative humidity. The condensed water at the condenser 120 may be collected in the reservoir 123. As used herein, relative humidity value refers to a ratio of the partial pressure of water vapor to the saturation vapor pressure of water at a given temperature.

The condenser 120 may include a sink electrode 125. The sink electrode 125 may be electrically grounded and/or may be connected to an electrical source 130 that imparts an electrical charge that is opposite to the electrical charge imparted to the source electrode 110. Although FIG. 1 shows an exemplary embodiment in which a common electrical source 130 supplies electrical charges to both the source electrode 110 and the sink electrode 125, the present disclosure is not limited thereto. The source electrode 110 and the sink electrode 125 may be connected to separate electrical sources.

The sink electrode 125 may include a condensing mesh. As shown in FIG. 3, the condensing mesh may include a plurality of layers 126, 127 and 128 to provide a sufficient surface area to allow the water vapor to stick to the surface of the condensing mesh and to condense on the surface of the condensing mesh. In operation, the condensed water vapor may coagulate with other condensed water vapor on the surface of the condensing mesh to form water droplets, and the water droplets may coagulate further with each other until they grow to be large and heavy. When they become sufficiently large and heavy, the water droplets may precipitate via gravity. The reservoir 123 may be disposed under the sink electrode 125 to collect the precipitating water droplets.

In the condensing mesh, as shown in FIG. 3, each of the plurality of layers 126, 127 and 128 may have a plurality of openings. Each opening 129 may have a characteristic dimension between 1 mm to 15 mm, depending on applications, flow rate requirements, neutralization efficiency, and the like. The characteristic dimension of each opening 129 may be the same among the plurality of the openings or may be different. The opening 129 of the plurality of layers 126, 127 and 128 may be aligned with each other or may be staggered to increase a chance for the aerosol to collide with the surface of the source mesh. The condensing mesh of the sink electrode 125 may be made of a conductive material. Examples of the materials to be used in the condensing mesh can include stainless steel, nickel, conductive polymers, and conductive silicone. Further, the condensing mesh may be made of and/or coated with a hydrophilic material to facilitate the condensation of water vapor on the mesh surface more easily. The sink electrode 125 may also be implemented with a liquid or a gas depending on the application and the use environment.

Similar to the source mesh, the condensing mesh may include a network of wires. The network of wires may include a plurality of interlaced or interwoven wires. Each layer of the condensing mesh may include a plurality of interlaced or interwoven wires that run in a predetermined pattern at substantially regular intervals. In this exemplary implementation of the condensing mesh, the characteristic dimension of the opening 129 may be defined by the regular intervals of the pattern. Alternatively, the condensing mesh may be formed as randomly woven wires. In this exemplary implementation, the characteristic dimension of the opening 129 may be defined by a maximum diameter of particles that can be passed without being filtered by more than a certain threshold transmission efficiency. For example, the characteristic dimension of the opening 129 may be said to be 1 mm if more than a certain percentage of the 1 mm particles can be transmitted through the condensing mesh. The threshold transmission efficiency may be 90%, but the present disclosure is not limited thereto. The wires that form the condensing mesh may have a diameter between 0.5 mm and 5 mm depending on applications, flow rate requirements, applied voltages, and the like. Although an example has been described for the wire mesh that includes horizontal wires and vertical wires, the present disclosure is not limited thereto. The condensing mesh may consist merely of horizontal wires or vertical wires. In some implementations, the source mesh and/or the condensing mesh can be helical shaped.

It may be generally desirable that the source mesh and the condensing mesh have minimal characteristic dimensions to provide a more finely distributed electrical field. However, a pressure drop across the meshes may require to be within a particular value to ensure sufficient air flow through the system. Accordingly, the pressure drop requirement may dictate the lower limit for the characteristic dimensions of the meshes.

As described above, the electrical source 130 may be electrically connected to the source electrode 110, the sink electrode 125, or both. In some embodiments, the electrical source 130 may be implemented as a direct current (DC) power supply with a voltage rating between 20 V and 10 kV. For example, the applied voltage may be 7 kV. The electrical power or voltage may be determined based on the size of the system, a process capacity of the system, and the like. In some embodiments, the electrical source 130 may be implemented as a direct current (DC) power supply with a voltage rating between 20 V and 9 kV; 20 V and 8 kV; 20 V and 7 kV; 20 V and 6 kV; 20 V and 5 kV; 20 V and 4 kV; 20 V and 3 kV; 20 V and 2 kV; 20 V and 1 kV; 1 kV and 9 kV; 2 kV and 8 kV; 3 kV and 7 kV; or 4 kV and 6 kV.

As shown in FIG. 1, the duct 140 may guide and direct the water vapor from the source electrode 110 side toward the sink electrode 125 side. In some embodiments, it may be undesirable if the charged vapor is attracted to surfaces of the duct 140. To address this issue, the surface of the duct 140 may be made to be electrically conducting. If the surface of the duct 140 is electrically conducting, several particles that are charged may be initially taken up by the surface of the duct 140, and may charge the entire surface of the duct 140 with the same charge as the water vapor. Once the surface of the duct 140 is charged with the same charge as the water vapor, other charged vapor that subsequently arrive may be repelled from the surface of the duct 140, thereby allowing the charged vapor to be transmitted through the duct 140 with a high transmission efficiency and without being lost to the surface of the duct 140.

Therefore, the duct 140 may include an electrically conducting material. In some implementations, the duct 140 may include (e.g., made of) an electrically insulating material such as a plastic, and the inside surface thereof may be coated or painted with an electrically conducting material. Depending on applications, the duct 140 may include a long flow path to dispose the source electrode 110 and the condenser 120 at separate locations. In such cases, the duct 140 may include flexible plastic or polymer materials and the inside surface thereof may be coated with an electrically conducting material.

On the other hand, in some applications, it may be desirable that the charged water vapor sticks to the surface of the duct 140 to increase overall vapor removal efficiency. In such cases, the duct 140 may include an electrically insulating material. In some implementations, the duct 140 may include (e.g., made of) an electrically conducting material and the inside surface thereof may be coated or painted with an electrically insulating material such as a plastic or a ceramic material. In some implementation, the duct 140 may be installed at an inclination with a predetermined angle going from a proximal end toward a distal end to allow the water droplets that have been condensed on the surface of the duct 140 to flow and be collected either at the proximal end or the distal end.

When the duct 140 includes an electrically conducting material, a particular portion near the source electrode 110 and the sink electrode 125 may include an electrically insulating material to prevent electric discharge between the electrodes and the duct 140. Further, the duct 140 may also include one or more flow straighteners.

The air stream may be forced (e.g., driven) through the duct 140 from the source electrode 110 side toward the sink electrode 125 side. To blow and guide the air stream through the duct 140, the system 100 may include a blower 150. The blower 150 may be implemented as an electric fan, an eductor pump, or the like. The system 100 may further include aerosol monitoring equipment (not shown), for example, an electrometer-based particle counter, a condensation particle counter (CPC), a scanning mobility particle sizer (SMPS), or the like. The system 100 may also monitor an electrical current that flows between the source electrode 110 and the sink electrode 125.

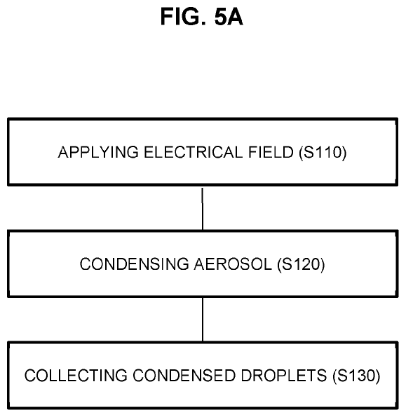

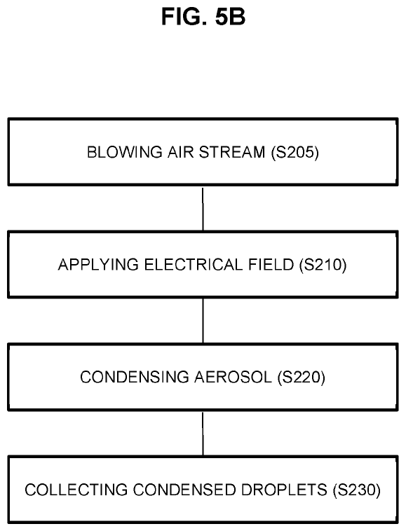

FIGS. 5A and 5B show process flow charts for a method for condensing aerosols according to exemplary embodiments of the present disclosure. Referring to FIG. 5A, the method may include steps of applying electrical field S110, condensing the aerosol S120, and collecting the condensed droplets S130. The step of applying electrical field SI 10 may be performed by a source electrode 110, which may be electrically connected to an electrical source 130 that may supply an electrical voltage to the source electrode 110. The step of condensing the aerosol S120 may be performed by a sink electrode 125, which may be either electrically grounded or connected to an electrical source 130 that imparts an electrical charge that is opposite to the electrical charge imparted to the source electrode. The source electrode 110 and the sink electrode 125 may be connected to a common electrical source 130 or may be connected to separate electrical sources. The step of collecting the condensed droplets S130 may be performed by a condenser 120 and a reservoir 123.

Referring to FIG. 5B, the method may include a step of blowing S205 by a blower 150 in addition to the steps of applying electrical field S210, condensing the aerosol S220, and collecting the condensed droplets S230. In some embodiments, the step of applying electrical field S110 and S210 may be performed with direct current (DC) power supply that generates a voltage rating between 20 V and 10 kV.

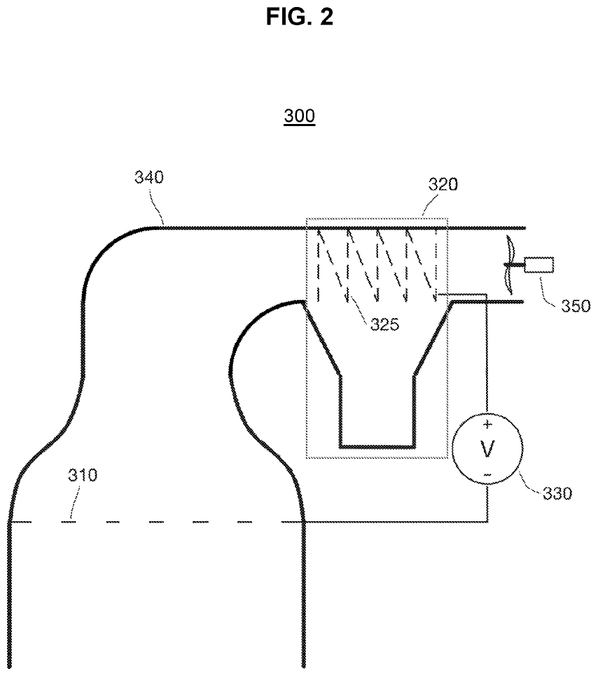

FIG. 2 is a schematic view of a system for condensing water in a cooling tower according to an exemplary embodiment of the present disclosure. The cooling tower to which the system 300 can be applied may include a cooling tower of a steam turbine exhaust. Referring to FIG. 2, the system 300 may include a source electrode 310 and a condenser 320 disposed within a duct 340.

The source electrode 310 may be electrically connected to an electrical source 330 that may supply an electrical voltage to the source electrode 310. As such, the source electrode 310 may create an electrical field within the duct 340. The source electrode 310 may include a source mesh.

The water vapor may be attracted to and collected at the condenser 320. The condenser 320 may be implemented substantially similar to the exemplary implementation shown in FIG. 4. For example, the condenser 320 may include a sink electrode 325. The sink electrode 325 may be electrically grounded, and/or may be connected to an electrical source 330 that imparts an electrical charge that is opposite to the electrical charge imparted to the source electrode 310. The source electrode 310 and the sink electrode 325 may be connected to a common electrical source 330 or may be connected to separate electrical sources. The sink electrode 325 may further include a condensing mesh.

The condensing mesh may allow the water vapor to stick to the surface thereof and to condense on the surface of the condensing mesh. In operation, the condensed water vapor may coagulate with other condensed water vapor on the surface of the condensing mesh to form water droplets. The water droplets may coagulate further with each other until they grow to be large and heavy. When they become sufficiently large and heavy, the water droplets may precipitate due to gravity. A reservoir may be disposed under the sink electrode 325 to collect the water droplets that precipitate.

As shown in FIG. 2, the duct 340 may guide and direct the water vapor from the source electrode 310 side toward the sink electrode 325 side. Generally, the steam turbine cooling towers already include an exhaust stream that is either forced or naturally drafted. Thus, the system 300 may scavenge and utilize the remaining enthalpy of the exhaust stream, e.g., to generate electric power. An example to extract electric power from the steam turbine exhaust is to include a wind turbine 350 at a downstream of the condenser 320. The electric power scavenged from the exhaust stream may be directly supplied to the electrical source 330 for operation of the system 300, or alternatively, may be stored in a battery (not shown) to be used later. Generating electricity in situ by scavenging waste enthalpy in the cooling tower exhaust and using the electricity on-site may increase the overall efficiency of the system 300. In an exemplary embodiment of the present disclosure, the wind turbine 350 may be disposed at the downstream of the condenser 320, but the present disclosure is not limited to such a configuration. The wind turbine 350 may also be disposed at an upstream of the condenser 320.

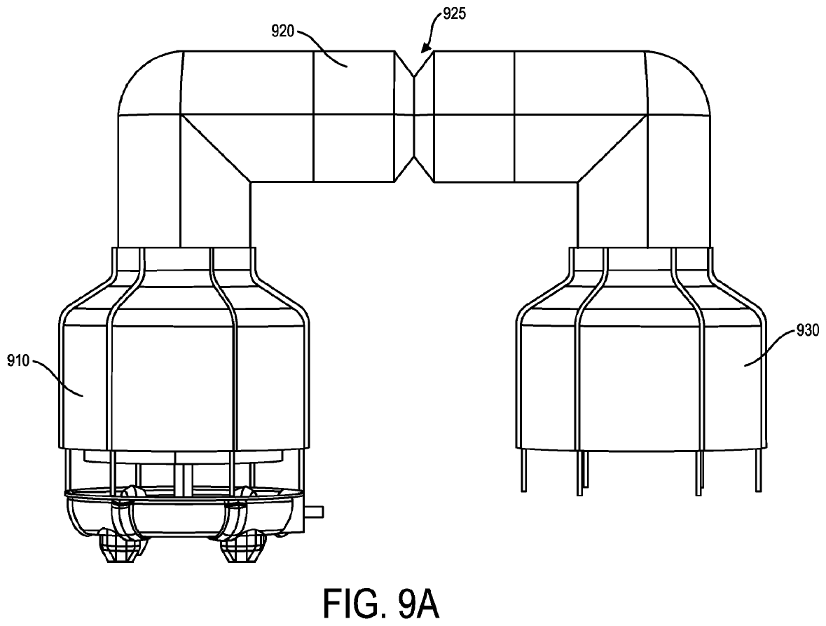

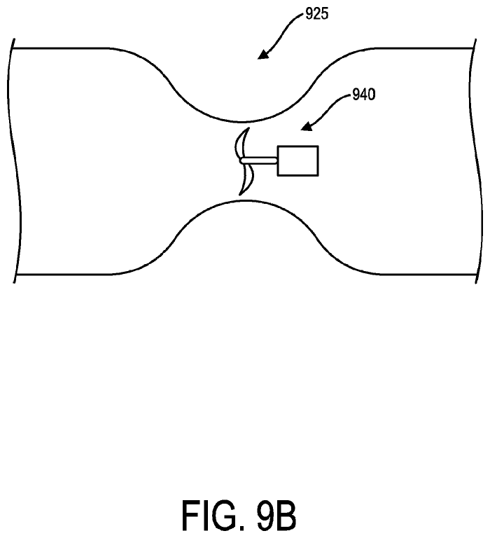

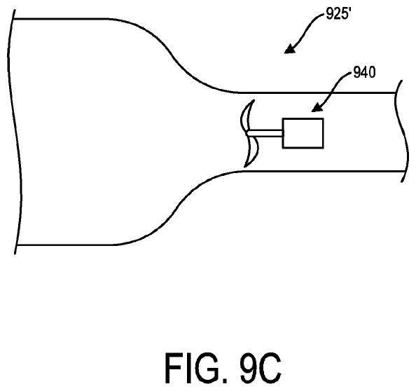

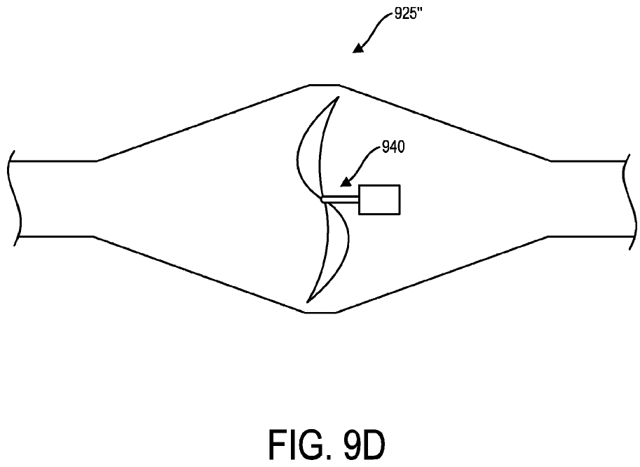

FIG. 9A illustrates an exemplary implementation in which the wind turbine is disposed at an upstream of the condenser. Referring to FIGS. 9A and 9B, the exhaust stream from a cooling tower 910 may be guided by a duct 920 toward a condenser 930. The duct 920 may include a converging-diverging portion 925. A wind turbine 940 may be disposed within the duct 920 at the converging-diverging portion 925. Remaining enthalpy of the exhaust stream may operate the wind turbine 940 to generate electric power, and the generated electric power may be used to operate the condenser 930. The converging-diverging portion may accelerate the exhaust flow to facilitate more effective scavenging of kinetic energy in the exhaust stream by the wind turbine 940. Moreover, extracting energy from the exhaust stream may decrease the temperature of the exhaust stream, and thereby allow the water vapor in the exhaust stream to condense more easily in the condenser 930.

In some implementations, as shown in FIG. 9C, the duct 920 may include a converging portion 925′ without a diverging portion. For example, a diameter of the cooling tower may be about 30 ft, and the duct may decrease the diameter gradually to about 5 ft prior to the wind turbine and the condenser. This configuration may accelerate the exhaust flow to allow the wind turbine 940 to generate greater power output and/or to allow the condenser system to be made smaller in overall size. Since the maximum theoretical power output from a wind turbine is generally proportional to the area of the blade disk and the cube of the wind velocity, the converging portion 925′ or converging-diverging portion 925 may increase the power output of the wind turbine 940 by increasing the wind velocity.

In some implementations, the duct 920 may include a diverging-converging portion 925″ as shown in FIG. 9D. In this configuration, the exhaust flow may decelerate at the diverging-converging portion 925″, and a wind turbine 940 with a greater diameter may be installed within the duct. The wind turbine 940 with the greater diameter may be rotated at a slower speed, which may reduce noise, frictional losses, system wear, or the like. In some implementations, a plurality of wind turbines may be disposed within the duct.

In some implementations, a cyclone feature can be included within the duct, which can cause the vapor flow to form a vortex (e.g., a spiral vortex), which can cause an increase in pressure thereby improving condensation. The cyclone feature can be located at any location within the duct prior to the condenser. In some implementations, the duct itself can be formed into a cyclone shape to induce the vortex. In some implementations, a separate cyclone (e.g., cyclone reactor) can be included. In some implementations, a fan can be included to further induce a spiral air flow.

The system may also be applied to combustion exhaust. The combustion exhaust may include combustion-based power stations such as, for example, coal-fired power plant and natural gas power plant, and internal combustion engines such as, for example, diesel engine and gasoline engine. In the typical combustion exhaust, non-volatile particles (e.g., solid-phase soot particles) and condensable gases (e.g., water vapor) exist as combustion products. To remove both non-volatile and volatile aerosols with high efficiencies, the system may be disposed upstream of an electrostatic precipitator (ESP) to scavenge water before the exhaust stream enters the ESP. Removing water and other condensable matter from the combustion exhaust prior to the ESP may protect the ESP from corrosion due to water or other acidic liquids. In the combustion exhaust implementation, the system may also be disposed upstream of a filter such as, for example, a high efficiency particular air (H EPA) filter, or a cyclone-type particle remover. Further, the system may be implemented with a heat exchanger disposed upstream of the system to recycle waste heat from the combustion exhaust.

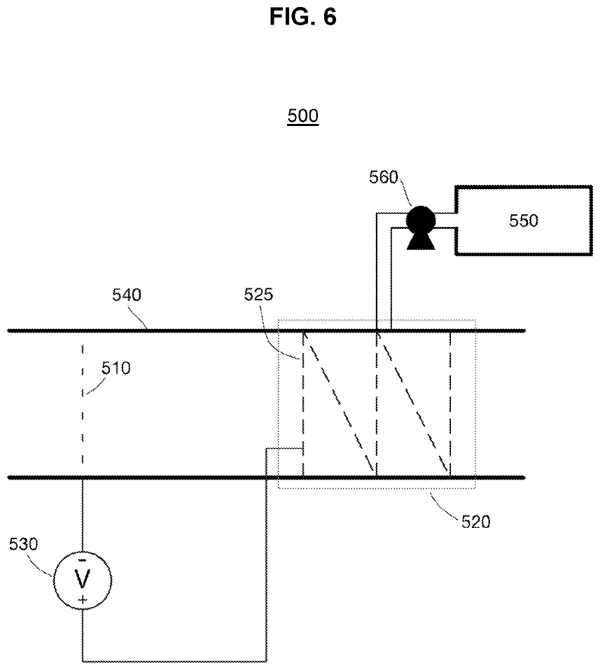

Another aspect of the present disclosure provides a system for humidity control. FIG. 6 illustrates a system for humidity control according to an exemplary embodiment of the present disclosure. Referring to FIG. 6, the system 500 may include a source electrode 510 and a humidity controller 520 disposed within a duct 540. The source electrode 510 may be electrically connected to an electrical source 530 that may apply an electrical voltage to the source electrode 510. The source electrode 510 may create an electrical field within the duct 540. The source electrode 510 may further include a source mesh.

The water vapor may be attracted to the humidity controller 520 due to the electrical field. The humidity controller 520 may include a sink electrode 525, and the sink electrode 525 may be electrically grounded, and/or may be connected to an electrical source 530 that imparts an electrical charge that is opposite to the electrical charge imparted to the source electrode 510. The source electrode 510 and the sink electrode 525 may be connected to a common electrical source 530 or may be connected to separate electrical sources. The sink electrode 525 may include a humidifying mesh.

The humidifying mesh may be dampened with water. In operation, the water vapor may be attracted to the humidifying mesh of the sink electrode 525. On the surfaces of the humidifying mesh, liquid water supplied to the humidifying mesh may be transferred to the attracted vapor and leave the surfaces of the humidifying mesh. Through this process, the relative humidity of the air stream that passes through the system 500 may be increased. The system 500 may include a water reservoir 550 to supply liquid water to the humidity controller 520. In some implementations, the liquid water may be supplied from the water reservoir 550 to the humidity controller 520 via gravity. To supply the liquid water by gravity, the water reservoir 550 may be disposed at a position higher than the humidity controller 520. In some implementations, the liquid water may be supplied from the water reservoir 550 to the humidity controller 520 by a pump 560.

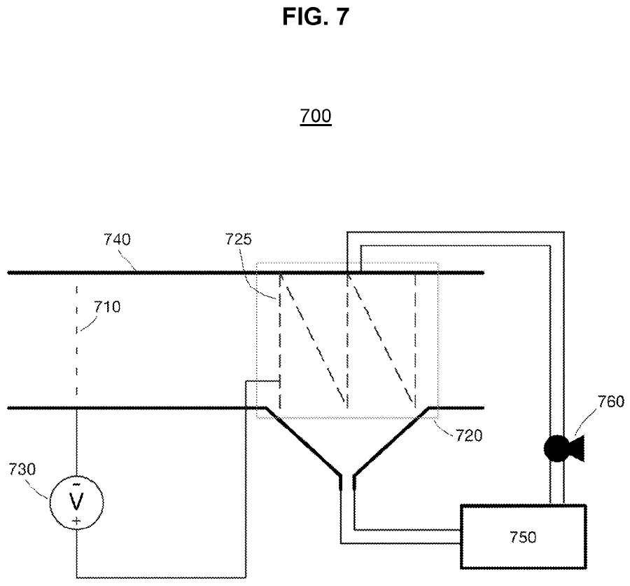

FIG. 7 illustrates a system for humidity control according to another exemplary embodiment of the present disclosure. Referring to FIG. 7, the system 700 may include a source electrode 710 and a humidity controller 720 disposed within a duct 740. The system 700 for humidity control may be implemented in various environments where a constant humidity is required. The source electrode 710 may be electrically connected to an electrical source 730 that may apply an electrical voltage to the source electrode 710. As such, the source electrode 710 may create an electrical field within the duct 740. The source electrode 710 may further include a source mesh.

The water vapor may be attracted to the humidity controller 720 due to the electrical field. The humidity controller 720 may further include a sink electrode 725. The sink electrode 725 may be electrically grounded, and/or may be connected to an electrical source 730 that imparts an electrical charge that is opposite to the electrical charge imparted to the source electrode 710. The source electrode 710 and the sink electrode 725 may be connected to a common electrical source 730 or may be connected to separate electrical sources. The sink electrode 725 may further include a humidity control mesh.

In operation, the water vapor may be attracted to the humidity control mesh of the sink electrode 725. On the surfaces of the humidity control mesh, liquid water that is present on the humidity control mesh may be transferred to the attracted vapor and leave the surfaces of the humidity control mesh. Alternatively, the attracted water vapor may stick to the surfaces of the humidity control mesh. When there is more water leaving the surfaces of the humidity control mesh than sticking to the surfaces of the humidity control mesh, the relative humidity of the air stream after passing through the system 700 may be increased. Conversely, when there is more water sticking to the surfaces of the humidity control mesh than leaving the surfaces of the humidity control mesh, the relatively humidity of the air stream may be decreased. Through this process, the relatively humidity of the air stream may be controlled to a particular level.

The system 700 may be operated to maintain the relative humidity of the air stream that passes through the system 700 at a preset target humidity. The preset target humidity may be adjusted by adjusting a voltage applied. The system 700 may include a water reservoir 750 to store condensed water from the humidity control mesh and/or to supply liquid water to the humidity controller 720. The liquid water may be supplied from the water reservoir 750 to the humidity controller 720 by a pump 760. To control the humidity more precisely, the system 700 may further include a feedback control system including a humidity sensor, a temperature sensor, a proportional-integral-derivative (PID) controller for generating and outputting a control signal to the voltage of the electrical source 730.

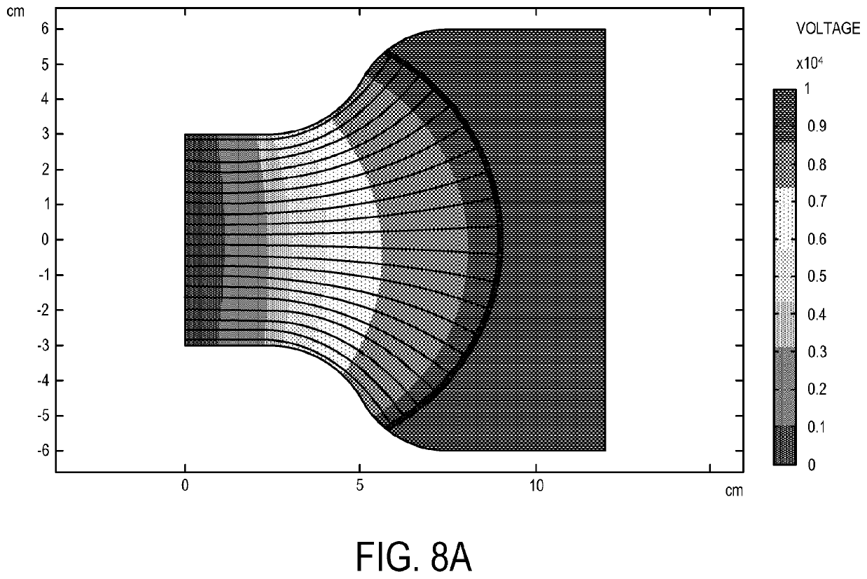

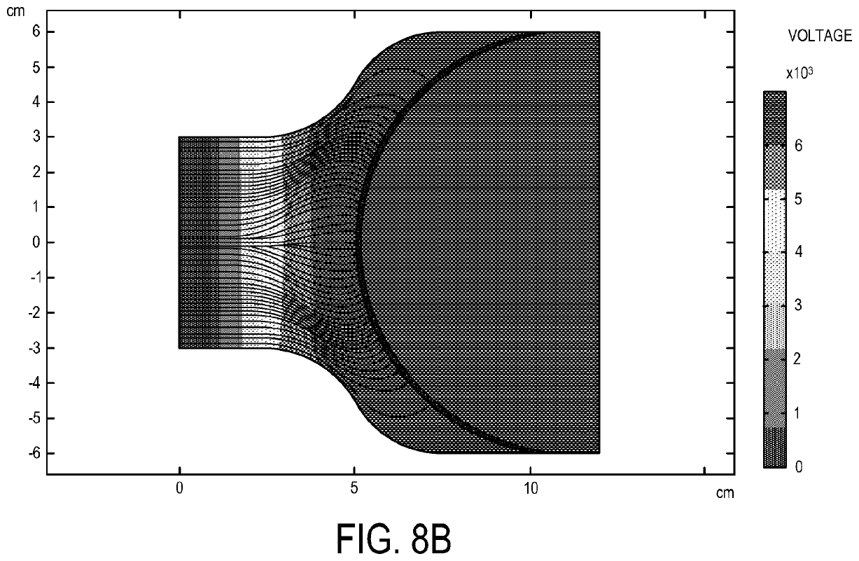

FIGS. 8A and 8B compare arrangements of the source electrode and the sink electrode to generate an electrical field according to exemplary embodiments of the present disclosure. In FIGS. 8A and 8B, the duct may be a diverging duct to impede (e.g., slow down) the air flow. The diverging duct may cause the pressure to increase and facilitate the condensation of water. FIG. 8A is an example of the sink electrode configured to be convex toward a downstream direction of the air flow and FIG. 8B is an example of the sink electrode configured to be concave toward the downstream direction of the air flow. It can be seen that a more smoothly-varying electrical field may be created when the sink electrode is configured to be convex toward the downstream direction of the air flow. Moreover, the applied voltage is an order of magnitude higher in FIG. 8A (convex configuration) than in FIG. 8B (concave configuration). Accordingly, the water vapor may be directed toward the sink electrode more effectively when the sink electrode is configured to be convex toward the downstream direction of the air flow. However, the foregoing configuration is merely an example, and the electrodes may be configured such that an electrical field with a particular configuration may be formed based on the operational requirements.

The subject matter described herein provides many technical advantages. For example, using the current subject matter, surrounding air may not be ionized, thereby limiting or preventing production of gases such as ozone (O₃), nitric oxide (NO), nitrogen dioxide (NO₂), and nitric acid (HNO₃). Further processing or treatment of collected liquid to address these toxic, corrosive, and environmentally dangerous compounds can be minimized or omitted. In addition, because the current subject matter can utilize lower voltages compared to some conventional systems, the current subject matter can be safer, may not waste large amounts of energy, and may not interfere with neighboring electronic instruments. Moreover, unlike some conventional approaches, the current subject matter does not pose a concern for explosion when the system is surrounded by debris with high surface areas (e.g., dust particles) and/or loose articles.

Although a few variations have been described in detail above, other modifications or additions are possible. For example, the vapor flow can be divided into more than one duct, which can have a separate source and/or sink electrode, and liquid collection.

In some implementations, a sprinkler or mister can be included with the condenser that sprays the condenser electrode (e.g., the condenser mesh) in order to facilitate droplet formation and gravity pulling the droplets. The ability of the condenser mesh to attract water molecules can be greater when less water has accumulated on the mesh. By including a mister or sprinkler to periodically spray additional water onto the condenser mesh, the mister or sprinkler can in effect cause the currently accumulated water on the condenser mesh to be pulled away by gravity sooner than would normally occur, and thereby improve the ability of the condenser mesh to attract the polar water molecules. In some implementations, a vibrator can be included to vibrate the condenser mesh to induce water to separate from the condenser mesh (e.g., to “drip” off the condenser mesh). The vibrator can be mechanical (e.g., a motor), ultrasonic (e.g., an ultrasonic generator), and/or the like.

Another aspect of the present disclosure provides a system and a method of monitoring and controlling a cooling tower system. The cooling tower is a heat exchanging system to dissipate heat through cooling a water stream (hot stream) to a lower temperature stream (cooled stream). Industrial cooling towers are typically used in power plants, petroleum refineries, petrochemical plants, natural gas processing plants, food processing plants, semi-conductor plants, and cement manufacturing plants. A cooling tower monitoring system (CTMS) according to an exemplary embodiment of the present disclosure may measure and analyze various parameters of the cooling tower, and provide a detailed monitoring of the performance of the cooling tower based on a comparison of the measured parameters with specification parameters of the cooling tower. The CTMS of the present disclosure may provide a single package solution to monitor and control the cooling tower operation to improve the overall cooling efficiency, increase longevity of the system by controlling the acidity of the cooled water, and reduce pollutant emissions from the cooling tower. The CTMS of the present disclosure may be installed at the time when a new cooling tower is built or may be retrofitted to existing cooling towers with minimal modifications to the existing cooling towers.

In a wet cooling tower (or open circuit cooling tower), the hot water may be cooled to a temperature lower than the ambient air dry-bulb temperature, if the air is relatively dry. As ambient air is drawn past a flow of water, a small portion of the water evaporates, and the energy required to evaporate that portion of the water is taken from the remaining mass of water, thus decreasing its temperature. Evaporation results in saturated air conditions, lowering the temperature of the water processed by the cooling tower to a value close to wet-bulb temperature, which is lower than the ambient dry-bulb temperature, and the difference is determined by the initial humidity of the ambient air.

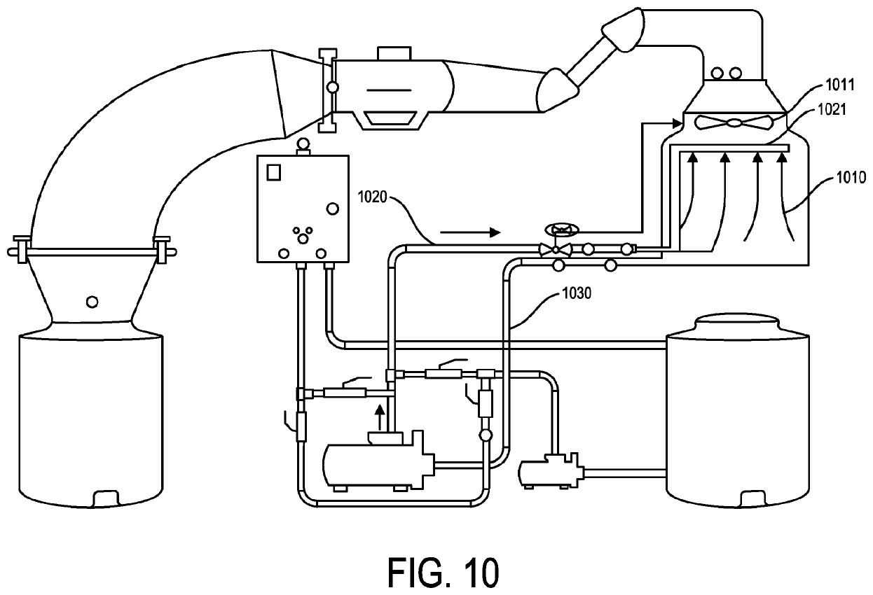

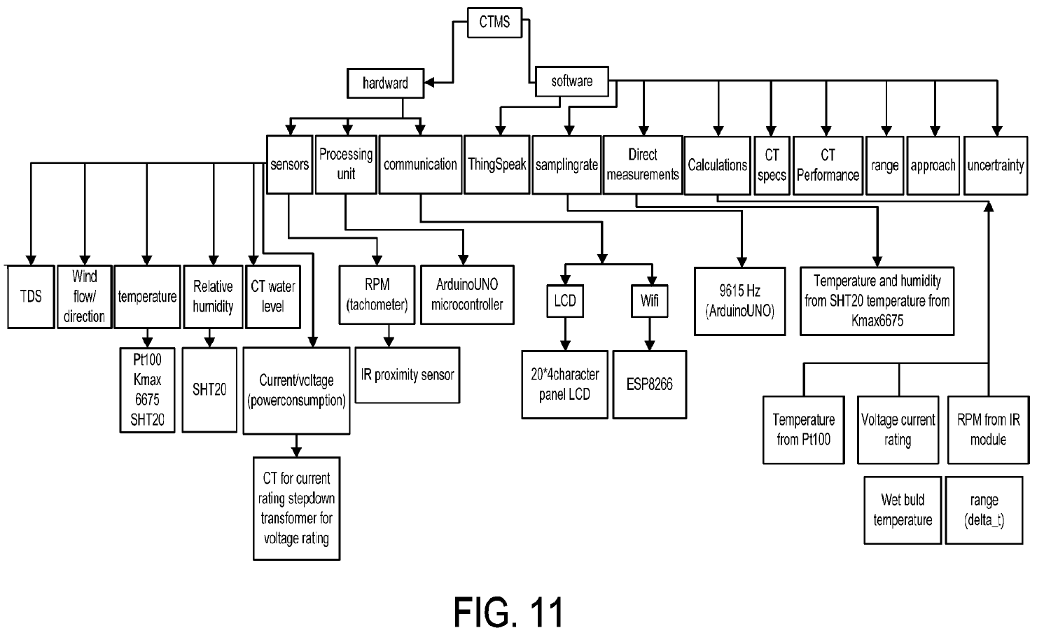

FIG. 10 shows a schematic view of a CTMS according to an exemplary embodiment of the present disclosure. Referring to FIG. 10, a hot water stream 1020 may be supplied to a cooling tower 1010. The hot water may be sprayed down by a spray head 1021. A fan 1011 provides an updraft of fresh air to cool the water. The water that has been cooled within the cooling tower 1010 may be returned through a cooled water stream 1030. FIG. 11 lists various elements of the CTMS according to an exemplary embodiment of the present disclosure. There may be hardware elements and software elements, and the hardware elements may include sensors, processing unit, and communication components.

Herein below, the sensor and the controller elements of the CTMS will be described. The CTMS according to an exemplary embodiment of the present disclosure may include a suite of sensors to monitor the health of a cooling tower. The suite of sensors may include a temperature sensor, a humidity sensor, a water level sensor, a tachometer, a voltage sensor, a current sensor, a pressure sensor, an anemometer, a water flow meter, or the like. The CTMS may further include a processor. A wired and/or a wireless communication system may also be included in the CTMS.

The temperature sensor may include a resistance temperature detector (RTD), e.g., Pt-100, or a thermocouple. In order to read the temperature data from the temperature sensors, a cold-junction compensated thermocouple reader may be used. For example, K-MAX 6675 may provide temperature data from the signal of type-K thermocouples. The temperature sensor may be combined or packaged with the humidity sensor such as SHT-20. An ultrasonic-type sensor such as HC-SR04 may be used as the water level sensor. To measure a rotational speed (rpm) of a fan of the cooling tower system, a tachometer may be used. Various types of tachometers, including a contact-type and a non-contact-type, may be used. When the CTMS is retrofitted to an existing cooling tower, non-contact-type tachometers may provide convenience over the contact-type tachometers. As such, an infrared-based tachometer may be used. To measure a power consumption of the cooling tower system, the voltage meter and/or the current meter may be included in the sensor suite of the CTMS. A barometric pressure sensor such as BMP-180 may be used as the pressure sensor to measure the pressure within the cooling tower system.

To collect the data from the sensors, process the sensor data, and generate control signals to operate the CTMS, a processor or a microcontroller may be included in the CTMS. The CTMS may include display devices to display the sensor data and/or the control parameters and to provide a user interface. Further, the CTMS may wirelessly communicate with some or all of the sensors through an Internet-of-Thing (IoT) platform. The sensor data and/or the control parameters may be displayed, calculated, and inputted through a software interface. The software interface may be implemented as a native software package or using a commercial control software such as Matlab or Labview. The software interface may determine the control parameters based on an algorithm to optimize the performance of the cooling tower. In determining the control parameters from the sensor measurement data, a parametric uncertainty analysis may be used.

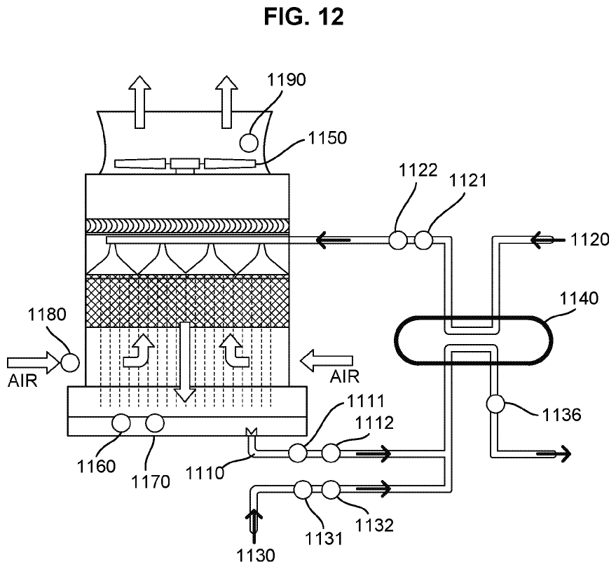

In operation, as shown in FIG. 12, the CTMS may measure a first temperature of a cooled stream 1110 and a second temperature of a hot stream 1120, and may calculate a temperature difference between the first temperature and the second temperature. A first temperature sensor 111I may measure the first temperature, and a second temperature sensor 1121 may measure the second temperature. Subsequently, the CTMS may adjust a first flow rate of the cooled stream 1110 and/or a second flow rate of the hot stream 1120 to allow the temperature difference between the cooled stream 1110 and the hot stream 1120 to correspond to a target temperature difference between the first temperature and the second temperature. To adjust the flow rates of the cooled stream 1110 and the hot stream 1120, a first valve 1112 and a second valve 1122 may be respectively used. The first valve 1112 and the second valve 1122 may be configured as a globe valve. For an automated operation and computerized control, the globe valve may be fitted with a solenoid actuator and operated by the controller.

In order to adjust the first temperature of the cooled stream, the CTMS may add a makeup stream 1130 into the cooled stream 1110. A mixing ratio of the makeup stream 1130 and the cooled stream 1110 may be determined based on the temperature difference between the first temperature and the second temperature. Herein, the makeup stream 1130 refers to a supply of water to replenish the water that evaporates and leaves the cooling tower, and the makeup stream 1130 may be supplied from any fresh water source. A third temperature sensor 1131 may provide a temperature data of the makeup stream 1130, and a third valve 1132 may adjust the flow rate of the makeup stream 1130. To more accurately control the CTMS, a fourth temperature sensor 1136 may be included at downstream of a heat exchanger 1140. In FIG. 12, both of the second temperature sensor 1121 and the fourth temperature sensor 1136 are shown to be disposed at downstream of the heat exchanger 1140. However, the position of the temperature sensors are not limited thereto, and one or both of the second temperature sensor 1121 and the fourth temperature sensor 1136 may be disposed at upstream of the heat exchanger 1140. Similarly, the second valve 1122 may be disposed at upstream of the heat exchanger 1140. In some implementations, heat exchanger 1140 can be omitted.

Further, to adjust the cooled stream temperature, a rotational speed of a fan 1150 of the cooling tower may be monitored and adjusted. To measure the rotational speed of the fan 1150, the tachometer 1190, e.g., infrared-based tachometer, may be used. The change of the fan speed may adjust a flow rate of cooling air, and thereby adjust the first temperature of the cooled stream 1110. Additionally, relatively humidity of the incoming air may be measured with a humidity sensor 1180.

Due to mineral accumulation, such as calcium carbonate, the cooled water stream of the cooling tower may become alkaline. In some implementations, an acidity/alkalinity (pH) of the cooled water may be monitored and controlled using a pH meter 1160. The acidity (or alkalinity) of the cooled water is an important factor that affects overall performance, longevity, and/or environmental impact of the cooling tower system. Accordingly, the CTMS may measure an acidity of the cooled stream 1110 and adjust the acidity by controlling the mixing ratio of the makeup stream 1130 and the cooled stream 1110. In addition to the pH measurement, the hardness of water may also be measured and controlled by the CTMS. In some implementations, the CTMS may also include a water level sensor 1170.

In some embodiments, a wind turbine, such as the one described above, may be added at the downstream of the fan 1150. The wind turbine may extract some enthalpy of the exhaust stream leaving the cooling tower, and convert it to electrical power. The scavenged electrical power may be recuperated to the CTMS system, and thereby increasing an overall power efficiency of the system.

In some implementations, the CTMS may control the power applied to the source electrode and/or condenser. The control can be in real time (e.g., near real time) and can be based on one or more sensors.

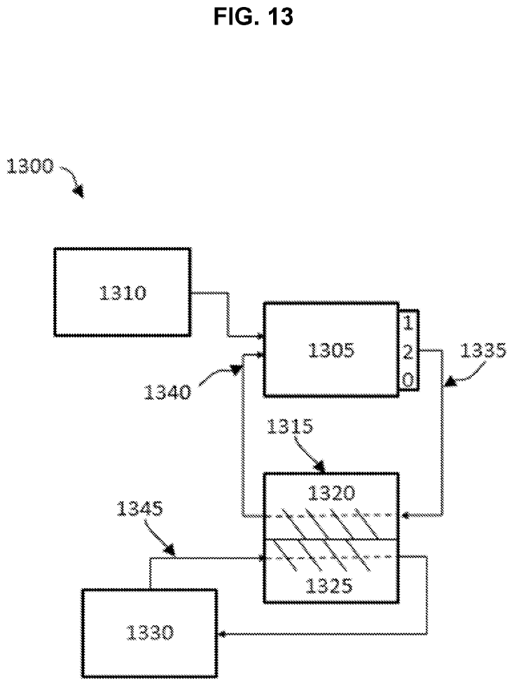

FIG. 13 is diagram illustrating a system for reducing thermal, chemical, and biological pollution according to an exemplary embodiment of the present disclosure. The system 1300 shown in FIG. 13 can be configured to remove chemical and biological pollutants from aerosol collected from a cooling tower. The system 1300 can further be configured to remove thermal pollution, or excess heat, from the aerosol that is collected from the cooling tower.

As shown in FIG. 13, the system 1300 includes a cooling tower 1305. The cooling tower 1305 can receive an input of a heated fluid or a hot water stream from a source 1310. The cooling tower 1305 can be coupled with a condenser, such as condensers 120, 320, 520, 720, and 930 shown and described in relation to FIGS. 1-2, 4, 6-7, and 9. The system 1300 also includes a heat exchanger 1315 coupled to the condenser 120. The heat exchanger 1315 includes a first region 1320 in which heated fluid 1335 condensed via the condenser 120 is received. The heat exchanger 1315 also includes a second region 1325 in which cooled fluid 1345 is received from a source 1330. Heat entrained within the heated fluid 1335 conveyed through region 1320 can be transferred to the cooled fluid 1345 in region 1325. In some embodiments, the source 1330 can include a naturally occurring source of cooled fluid, such as a reservoir, a river, a lake, a stream, or the like. In some embodiments, the source 1330 can include a man-made source of cooled fluid, such a container, vessel, or system configured to store a fluid suitable for providing a cooling fluid for use in a heat exchanger. The system 1300 is configured to provide a lower-temperature fluid 1340, which is output from the heat exchanger 1315, as an input to the cooling tower 1305. In this way the system 1300 can operate as a closed-loop system to remove or reduce chemical, biological, and thermal pollutants which may be introduced from or be present within the heated fluid or hot water stream that is received from the source 1310. In this way, the system 1300 can advantageously prevent pollutants from being released into the atmosphere from exhaust exiting the cooling tower 1305.

In operation, the system 1300 can maintain any chemical and biological pollutants which can be present in the heated fluid received from the source 1310 within the closed-loop configuration provided by the heat exchanger 1315 coupled to the cooling tower 1305. The condenser 120 can scavenge fluid condensed from the aerosol exhausted via the cooling tower 1305 and can provide the fluid as heated fluid 1335 to region 1320 of the heat exchanger 1315. The heat exchanger 1315 can form a sealed, closed-loop configuration with the cooling tower 1305 and the condenser 120 that can prevent any chemical or biological pollutants from being released into the environment.

The system 1300 can also reduce or remove thermal pollutants which can be present in the heated fluid received from the source 1310. For example, by coupling the heat exchanger 1315 to the condenser 120, heat within the heated fluid 1335 can be transferred to the cooled fluid 1345 so that the lower-temperature fluid 1340 returned to the cooling tower 1305 can include fewer thermal pollutants. In this way, the system 1300 can operate to remove any excess heat or thermal pollutants which may be present in the heated fluid 1335 and/or heated fluid that is received from source 1310. In some embodiments, the heat exchanger 1305 can be configured in close proximity to the source 1330. For example, in some embodiments, the source 1330 of cooled fluid 1345 can be a lake or a river. The heat exchanger 1315 can be located near or immediately next to the source 1330.

In some scenarios, it may be beneficial to recollect water from a cooling tower in order to increase the efficiency of a system in certain environmental conditions. These conditions can include dryer climates where sourcing cooling water is difficult. Additionally, the benefit of having a cooling tower which is closed system allows for the control of pollution being emitted from the system.

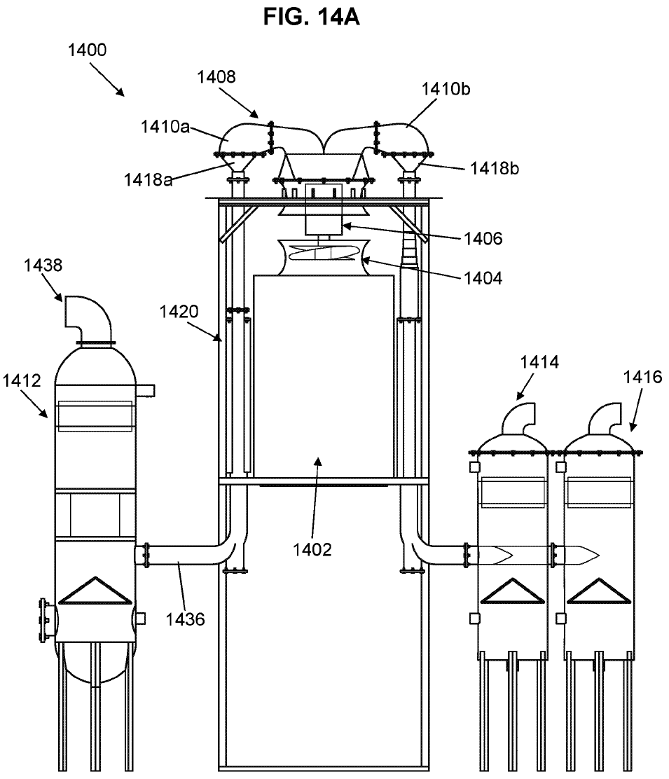

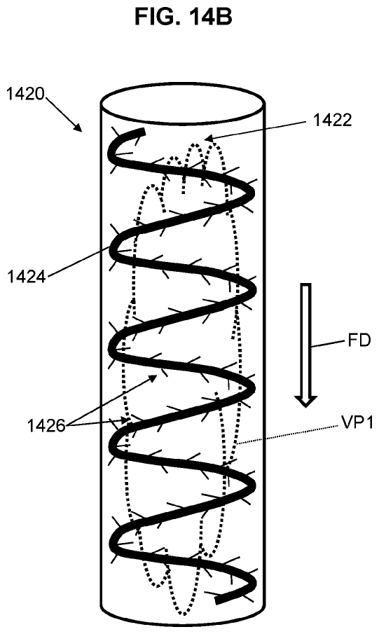

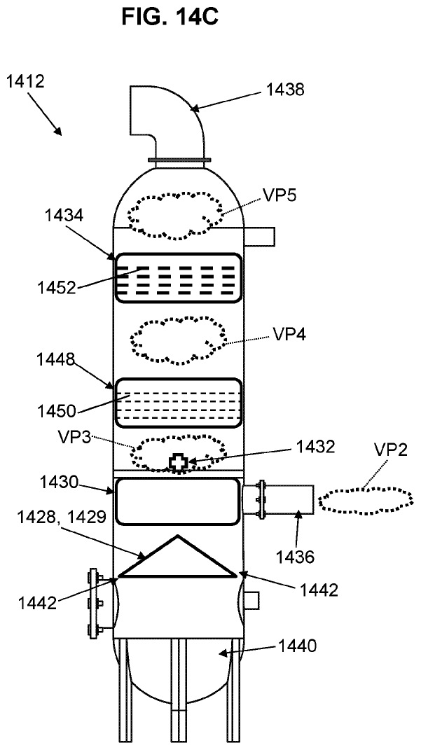

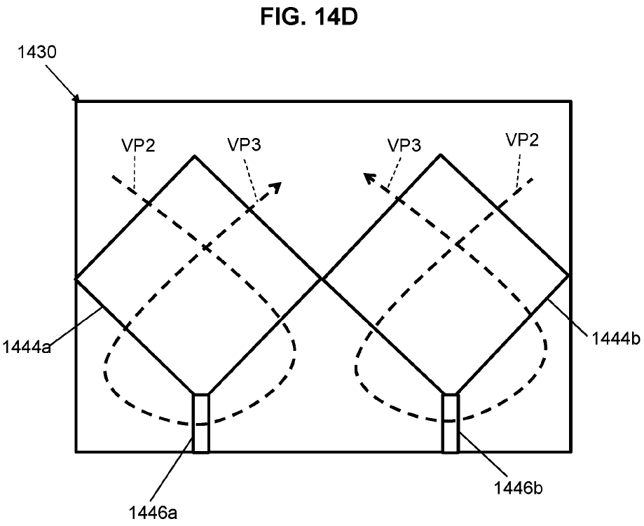

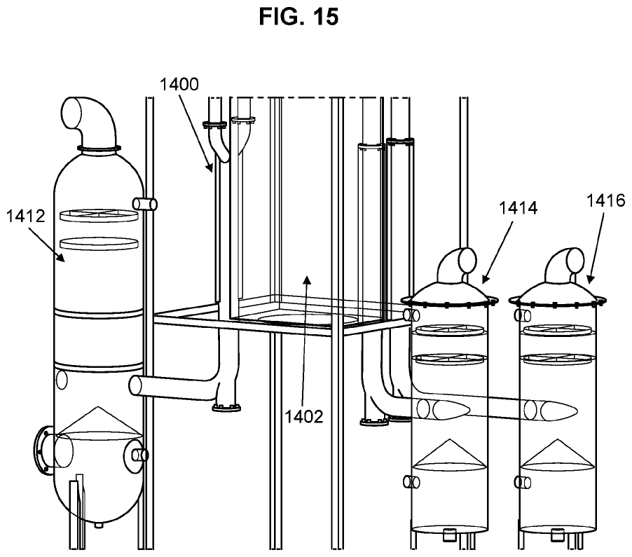

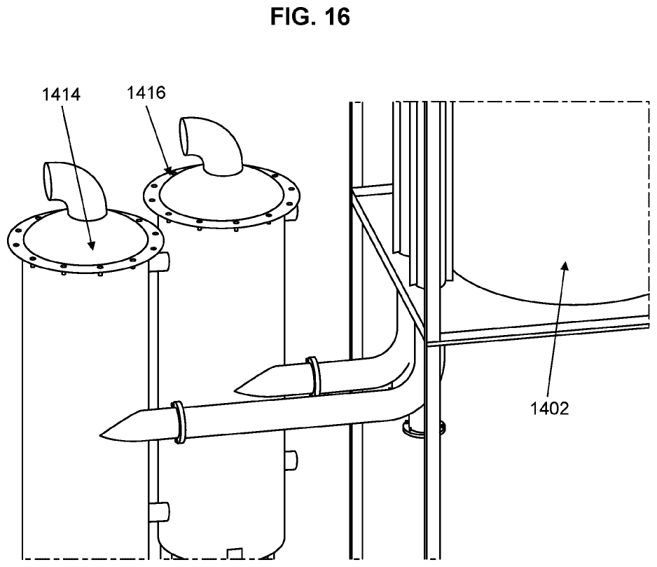

FIG. 14A-16 illustrate an embodiment of a system 1400 for condensing a vapor product from a cooling tower 1402. A vapor product is generated due to a process occurring within the cooling tower 1402, or at some location external to the cooling tower 1402, with a coolant being passed through a heat exchanger within the cooling tower 1402 in order to reduce the coolant temperature. As a byproduct of this heat exchange process, a vapor product, formed from a liquid such as water, is generated and passed upward and out of the cooling tower 1402. The vapor product. In some implementations, the vapor product can be in the form of water vapor (e.g., gas-phase molecules). Vapors are typically colorless (e.g., invisible) and non-wetting but can condense and/or react on contact with liquid and/or solid. In some implementations, the vapor product can be in the form of an aerosol (e.g., a visible aerosol containing water droplets (e.g., liquid particles) with a size of about 1 nm to 10 μm or greater (e.g., liquid water particles suspended in a carrier gas, such as air).

The cooling tower 1402 includes a reaction chamber where the heat exchange process occurs, an opening 1404 arranged within the top of the cooling tower 1402, and a blower 1406 arranged within the opening 1404. The heat exchange process can be conducted by any suitable heat exchange process known which produces a vapor product. The blower 1406 is arranged in the opening in order to produce a vacuum force which aids in directing the vapor product out of the cooling tower 1402. The blower 1404 can be any form of air movement device, such as a fan or turbine connected to a power source, such as an electric motor.

Arranged on the other side of the blower 1406 and configured to receive the vapor product is a duct system 1408. The duct system 1408 includes first and second ducts 1410a, 1410b arranged above the cooling tower 1402. The first and second ducts 1410a, 1410b are each configured to collect a respective portion of the vapor product being emitted from the cooling tower 1402. The vapor product has a first humidity level. A humidity level is the amount of water, either in gaseous or particulate form, which is present within a vapor product. In some embodiments, the first duct 1410a is in fluid communication a chamber 1412 arranged downstream of the first duct 1410a. In order to draw the vapor product through the system, the first duct 1410a having a first charge in response to application of a first voltage to the first duct 1410a so as to ionize the vapor product. In some embodiments, the first duct 1410a is curved to redirect the vapor product towards the chamber 1412.

Alternatively, or in addition to, the duct system 1408 can include an additional duct 1410b that is in fluid communication with at least one chamber 1414. Alternatively, or in addition to, the duct system 1408 can include yet another additional duct (obstructed) that is in fluid communication with at least one chamber 1416. The at least one chambers 1414, 1416 can be substantially similar to chamber 1412, and therefore common features are not described in detail herein. A person skilled in the art would appreciate that the above description of the first duct 1410a is also applicable to the additional duct 1410b.

At this stage in the process, the vapor product includes liquid particles of water, which as described in detail below, will be at least partially removed from the vapor product at subsequent stages of the process. Arranged at an outlet end of the first duct 1410a is a reducer 1418a configured to increase the flow rate of the vapor product passing therethough. The reducer 1418a is a conical-shaped tube which has a reduced the cross-sectional area compared to the first duct 1410a in order to increase the speed of the liquid particles within the ionized vapor product VP1. By increasing the speed of the ionized vapor product VP1, the liquid particles within the ionized vapor product VP1 are separated from one another within the ionized vapor product VP1.

Alternatively, or in addition to, a reducer 1418b can be arranged at the outlet end of the additional duct 1410b and configured to increase the flow rate of the vapor product pass therethrough. The reducer 1418b can be substantially similar to reducer 1418a, and therefore common features are not described in detail herein. A person skilled in the art would appreciate that the above description of the reducer 1418a is also applicable to the reducer 1418b.

After passing through the reducer 1418a, the ionized vapor product VP1 passes into a second duct 1420. A schematic view of the duct 1420 is illustrated in FIG. 14B. The second duct 1420 is arranged downstream of the first duct 1410a and includes a passageway 1422 for the ionized vapor product to pass therethrough. In some embodiments, the second duct 1420 can include a spiral electrode 1424 within the passageway 1422. The spiral electrode 1424 is shaped such that the spiral is formed in the same direction as the ionized vapor product VP1 is spiraling in order in the flow direction FD to aid in moving the ionized vapor product VP1 through the duct 1420. The spiral electrode 1424 can include a plurality of point electrodes arranged along the length of the spiral electrode 1424. The point electrodes 1426 are arranged within the flow path of the ionized vapor product VP1 passing through the duct 1420 in order to impart a second charge to the liquid particles. The spiral electrode 1424 has a second charge in response to application of a second voltage that is different than the first voltage to allow collection of liquid particles present in the ionized vapor product passing through the second duct 1420. By passing the ionized vapor product VP1 through the second duct 1420, the second duct 1420 forms a first modified vapor product VP2 with a first modified humidity level that is greater than the first humidity level. The second voltage is opposite the first voltage such that the liquid particles of the first modified vapor product VP1 are attracted to the duct 1420 from the duct 1410a. In some embodiments, as the vapor product VP passes through each successive stage of the system, the charge imparted to the vapor product VP is alternated to aid in passing the vapor product VP through the whole system.

After passing through the duct 1420, the first modified vapor product VP2 is primed to having liquid removed from the first modified vapor product VP2. The chamber 1412 is arranged downstream of the first and second ducts 1410a, 1420 and configured to receive the first modified vapor product from the second duct 1420. The chamber 1412 can be arranged in a vertical or horizontal configuration, and is configured to pass the first modified vapor product VP2 through various components in order to remove liquid from the first modified vapor product VP2. The chamber 1412 is configured to receive the first modified vapor product VP2, with the chamber 1412 including a separator 1428, a TEC unit 1430, a point electrode 1432, and a demister 1434. An inlet 1436 can be configured to receive the first modified vapor product VP2 from the second duct 1420 with the first modified vapor product VP2. An outlet 1438, arranged at the opposite end of the chamber 1412, can be configured to discharge a vapor product (e.g., the fourth modified vapor product) after the first modified vapor product has passed through the separator 1428 to form a second modified vapor product, the TEC unit 1430 to form a third modified vapor product, the point electrode 1432 to form an ionized third modified vapor product, and the demister 1434 to form a fourth modified vapor product. The second modified vapor product VP3 has a second modified humidity level that is less than the first modified humidity level of the first modified vapor product VP2. At the outlet 1438, the fourth vapor product has a humidity level which is lower than at least the first humidity level and the first modified humidity level due to the removal of liquid from the vapor product. In some embodiments, the system can include a reservoir 1440 configured to collect the separated liquid from each of the modified vapor products. In some embodiments, as shown in FIG. 14C, the reservoir 1440 can be positioned underneath the separator 1428

Due to the blower 1406, the vapor product is moving through the system 1400 at an accelerated flow rate. This flow rate could potentially cause additional evaporation to already removed liquid in the reservoir 1440 if not properly separated within the chamber 1412. The separator 1428 is configured to direct liquid particles from at least the first modified vapor product VP2 and into a reservoir 1440 within the chamber 1412. While the separator can have a variety of configurations, in some embodiments, as shown in FIG. 14C, the separator 1428 is a plate 1429 arranged above and proximate to the reservoir 1440. In some embodiments, the separator 1428 can include a conical-shaped plate 1429 arranged within the chamber 1412. In order to allow the separated liquid to flow into the reservoir 1440, the separator 1428 is arranged such that a gap 1442 is formed between the internal sidewall of the chamber 1412 and the edge of the separator 1428. In some embodiments, the gap 1442 between the separator 1428 plate and the internal sidewall is 1-5 millimeters, and preferably 2 millimeters.

In order to efficiently removed liquid from the first modified vapor product VP2, the first modified vapor product VP2 is cooled down within the chamber 1412. Arranged proximal to the inlet of the chamber 1412 is a thermoelectric cooling (TEC) unit 1430 formed from a plurality of baffles 1444a, 1444b, such as plates, and a plurality of cooling plates 1446a, 1446b configured to cool the first modified vapor product VP2. In some embodiments, the cooling plates 1446a, 1446b are thermoelectric coolers (TEC). Any commonly known TEC can be used in order to cool the first modified vapor product VP2 passing through the chamber 1412. A common TEC includes two unique semiconductors, one n-type and one p-type, are used because they need to have different electron densities. The alternating p & n-type semiconductor pillars are placed thermally in parallel to each other and electrically in series and then joined with a thermally conducting plate on each side, usually ceramic removing the need for a separate insulator. When a voltage is applied to the free ends of the two semiconductors there is a flow of DC current across the junction of the semiconductors, causing a temperature difference. The side with the cooling plates 1446a, 1446b absorbs heat which is then transported by the semiconductor to the other side of the device.

Each baffle 1444a, 1444b can include a cooling plates 1446a, 1446b thermally coupled to the baffles 1444a, 1444b, which can be formed from a conductive metal such as steel. As illustrated in FIG. 14D, the vapor product VP can be fed into the chamber 1412 through the inlet to pass over the baffles 1444a, 1444b and cooling plates 1446a, 1446b as the first modified vapor product VP2 swirls within the chamber 1412. As the first modified vapor product VP2 swirls through the cooling plates 1446a, 1446b, the cooling plates 1446a, 1446b will reduce the temperature of the first modified vapor product VP2 to form a second modified vapor VP3 product having a second modified humidity level that is less than the first modified humidity level. Due to this reduction in temperature, liquid particles are separated from the second modified vapor product VP3 and condense on the baffles 1444a, 1444b.

In order to draw the second modified vapor product VP3 up through the chamber 1412, a point electrode 1432 is arranged vertically above the TEC unit 1430. The point electrode 1432 is electrically charged with a third voltage. The third voltage can be opposite the second voltage and identical to the first voltage in order to attract the second modified vapor product VP3 to the point electrode 1432. Additionally, in some embodiments, an at least one second mesh plate 1450 or a series of mesh plates 1448 is positioned between the point electrode 1432 and an at least one first mesh plate 1452, which is described in detail below. The at least one second mesh plate 1450 is configured to collect at least a portion of liquid particles present within the second modified vapor product VP3 to form a third modified vapor product VP4 having a third modified humidity level that is less than at least the second modified humidity level. The series of mesh plates 1448 can be arranged vertically above the point electrode 1432. Each of the mesh plates within the series of mesh plates 1448, including the second mesh plate 1450, are similar to the point electrode 1432 where each plate in the series of mesh plates 1448 is charged with alternating voltage in order to move the second modified vapor product VP3 through the chamber 1412. In other embodiments, the second mesh plate 1450 can include a plurality of layers each of which include a network of wires. In some embodiments, the layers formed by the mesh plates in the series of mesh plates 1448 are separated 1-4 inches between each layer. As the second modified vapor product VP3 passes through the second mesh plate 1450, liquid particles can be separated from the second modified vapor product VP3 and coalesce on the wires of the second mesh plate 1450 to form a third modified vapor product VP4 having a third modified humidity level that is less than at least the second modified humidity level. As the water droplets coalesce on the second mesh plate 1450, they will grow in size until separating from the wire and falling into the reservoir 1440 arranged in the bottom of the chamber 1412.

Arranged in proximity to the outlet 1438 of the chamber 1412 is at least one mesh plate 1452 forming the demister 1434. The demister 1434 may be a mesh-type, vane pack, or other structure intended to aggregate the mist into droplets that are heavy enough to separate from the third modified vapor product VP4. In some embodiments, at least one mesh plate 1452 of the demister 1434 can include a coalescing mesh, the coalescing mesh including a network of wires. In other embodiments, the at least one mesh plate 1452 can be configured to coalesce the third modified vapor product VP4 to form droplets, which precipitate by at least gravity. In some embodiments, the demister 1434 can include a plurality of mesh layers and be configured to have each mesh layer be charged with an alternating voltage in order to attract the liquid particles to the mesh layers. The at least one mesh plate 1452 has a third charge in response to application of a third voltage that is different than the second voltage. After passing through the demister 1434, the third modified vapor product VP4 has substantially most to all liquid particles removed to form a fourth modified vapor VP5 product having a fourth modified humidity level that is less than at least the second modified humidity level.

When the third modified vapor product VP4 with mist rises at a constant speed and passes through the wire mesh layers of the demister 1434, the rising third modified vapor product VP4 will collided with the filament of the mesh plates 1452 and attached to the surface filament due to the inertia effect. The third modified vapor product VP4 will be diffuse on the filament surface and the water droplet will follow along the filaments. The water droplet will grow bigger and isolate from the filament until the droplets gravity exceeds the third modified vapor product VP4 rising force and liquid surface tension force while there is little gas passing through the demister 1434.

In use, a method of condensing a vapor product can be utilized using the system 1400. The vapor product is passed through the first duct 1410a, which is electrically charged with the first voltage, in order to ionize the vapor product. This creates the ionized vapor product VP1. The ionized vapor product VP1 is passes through a second duct 1420 positioned downstream of and in fluid communication with the first duct 1410a to form the first modified vapor product VP2. The second duct 1420 is electrically charged with the second voltage that is different than the first voltage. The first modified vapor product VP2 passes into the chamber 1412 to further remove liquid from the first modified vapor product VP2. The chamber 1412 has the at least one cooling plate 1446a and at least one first mesh plate 1452 positioned downstream of the at least one cooling plate 1446a. The first mesh plate 1452 is electrically charged with the third voltage that is different than at least the second voltage. The first modified vapor product VP2 is cooled, by the at least one cooling plate 1446a, to form the second modified vapor product VP3. As the second modified vapor product VP3 moves through the chamber 1412, the first mesh plate 1452 removes at least a portion of liquid particles present within the second modified vapor product VP3 or the third modified vapor product VP4 to form the fourth modified vapor product VP5, which can be exhausted form the chamber 1412 through the outlet 1438.

The vapor product has a first humidity level, the first modified vapor product VP2 has a first modified humidity level that is greater than the first humidity level, the second modified vapor product VP3 has a second modified humidity level that is less than the first humidity level, and the fourth modified vapor product VP5 has a third humidity level that is less than the second modified humidity level.

The chamber 1412 includes the separator 1428 positioned between the inlet 1436 of the chamber 1412 and the cooling plate 1446a. In use, prior to removing liquid from the first modified vapor product VP2, the separator 1428 can separate at least a portion of liquid particles present within the first modified vapor product VP2.

The point electrode 1432 is electrically charged with a fourth voltage that is deferent than at least the third voltage. In use, the point electrode 1432 ionizes the second modified vapor product VP3 that passes across or proximate to the point electrode 1432 to modify the electrical charge of the second modified vapor product VP3.

The chamber 1412 includes the second mesh plate 1450. In use, the second mesh plate 1450 removes at least a portion of liquid particles present within the second modified vapor product VP3 to form a third modified vapor product VP4 having a third modified humidity level that is less than at least the second modified humidity level.

The reducer 1418a is positioned between the first duct 1410a and the second duct 1420. In use, the reducer 1418a increases a flow rate of the ionized vapor product VP1 as it passes therethrough and towards the second duct 1420.

The second duct 1420 includes a spiral electrode 1424 disposed within the second duct 1420. The spiral electrode 1424 is electrically charged with the second voltage. In use, passing the ionized vapor product VP1 through the second duct 1420 includes passing the ionized vapor product VP1 across the spiral electrode 1424 to allow at least a portion of liquid particles present within the ionized vapor product VP1 to collect on the spiral electrode 1424. The collection of the liquid particles selectively separates from the spiral electrode 1424 such that the combination of the collection of liquid particles and the remaining ionized vapor product VP1 form the first modified vapor product VP2. In use, liquid particles selectively separated from at least the first modified vapor product VP2 and the second modified vapor product VP3 are collected and transferred to the reservoir 1440.

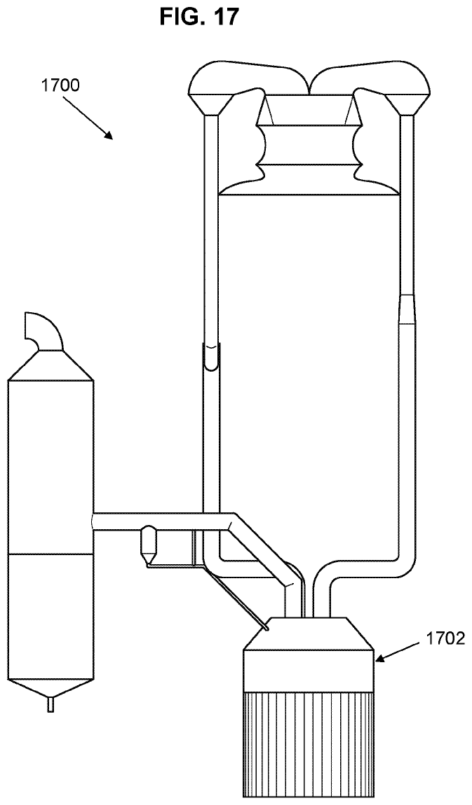

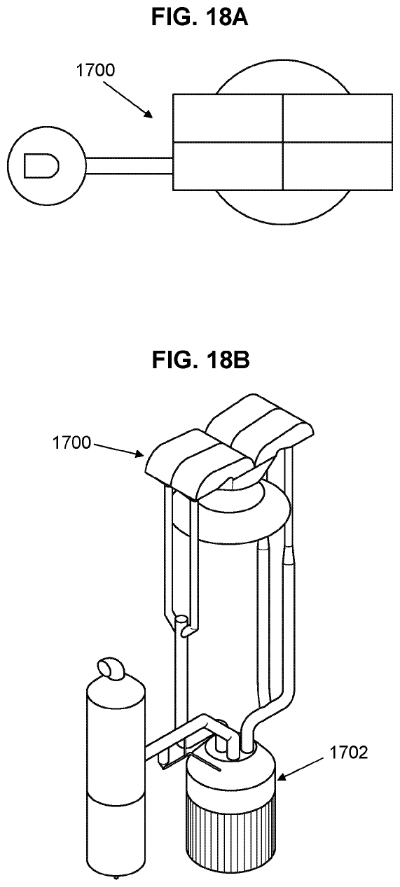

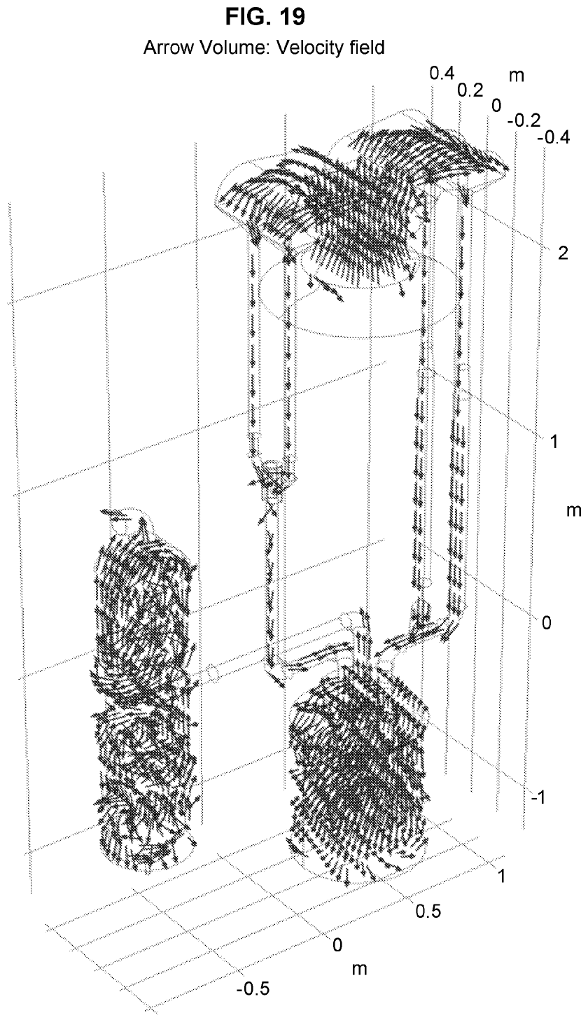

FIGS. 17-18B illustrate another example embodiment of a condensing system 1700. The system 1700 is substantially similar to the system 1400, but includes an additional chamber 1412 1702 for cooling and condensing the vapor product in series with the other chamber. FIGS. 19-25 illustrate various operational characteristics of the example implementation shown in FIGS. 17-18B. As illustrated in FIGS. 17-18B, the example systems for condensing vapor includes four ducts for directing or guiding water vapor from a source electrode toward a condenser electrode (e.g., sink electrode). The four ducts are made of conductive material.

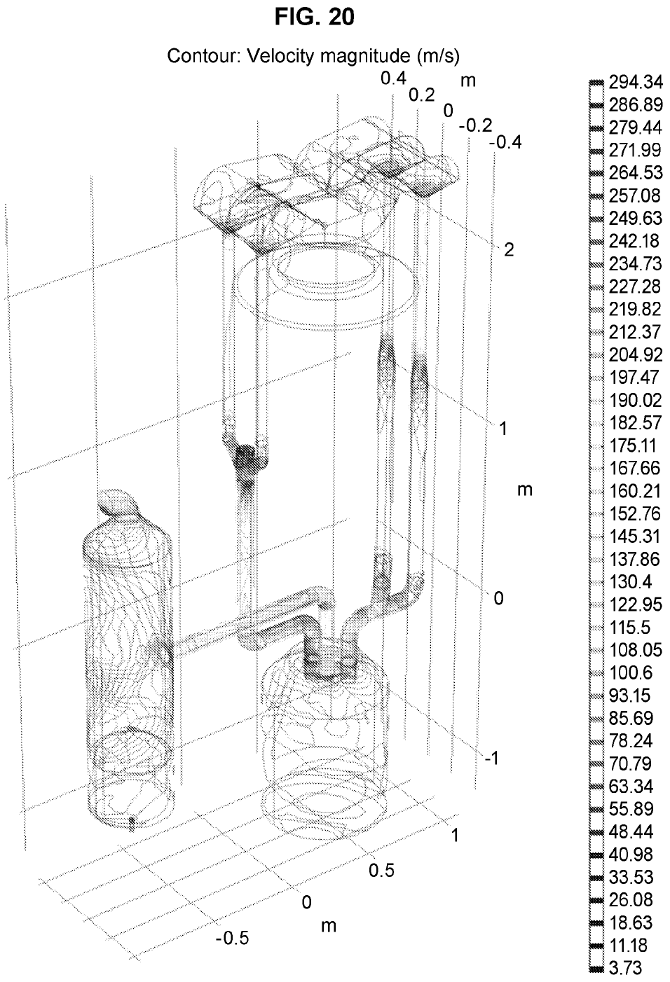

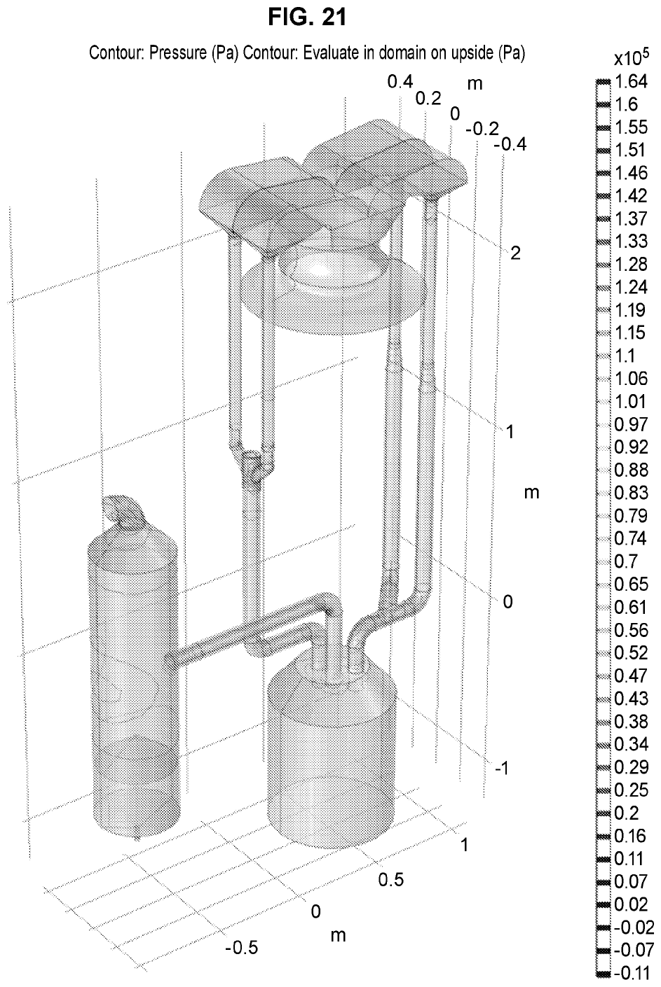

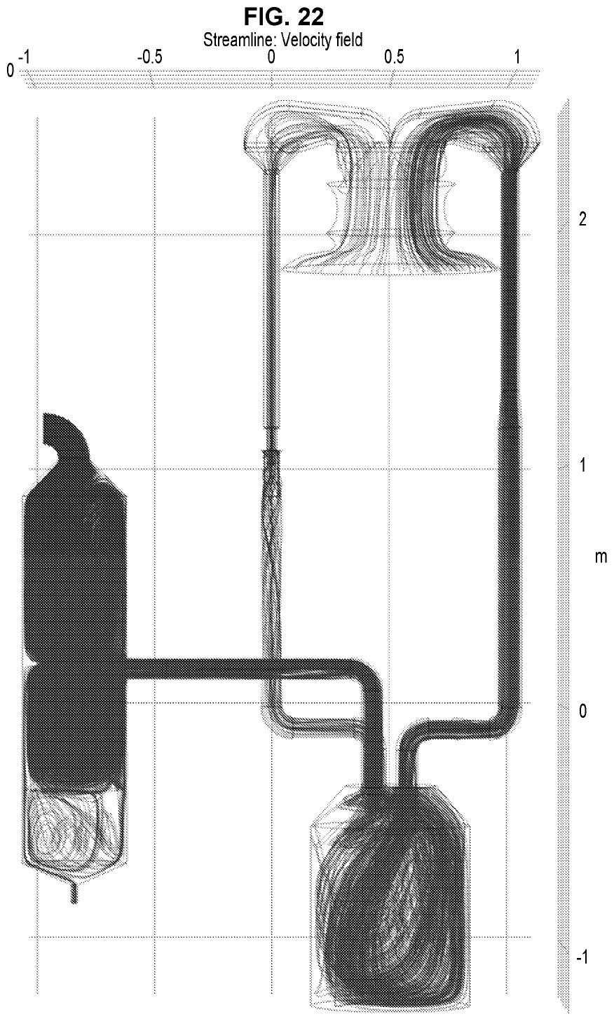

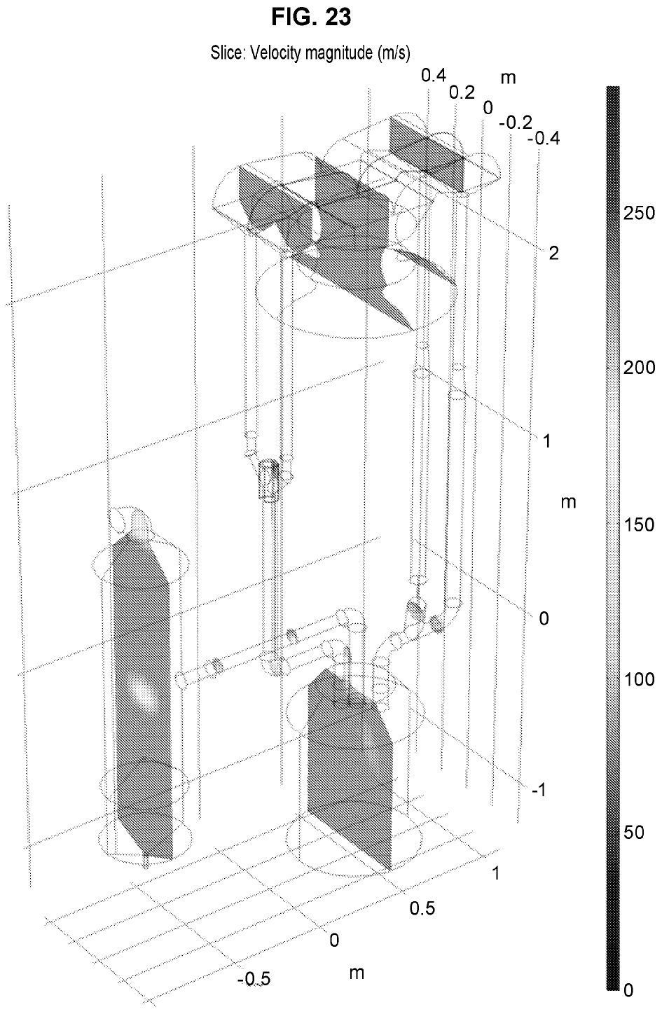

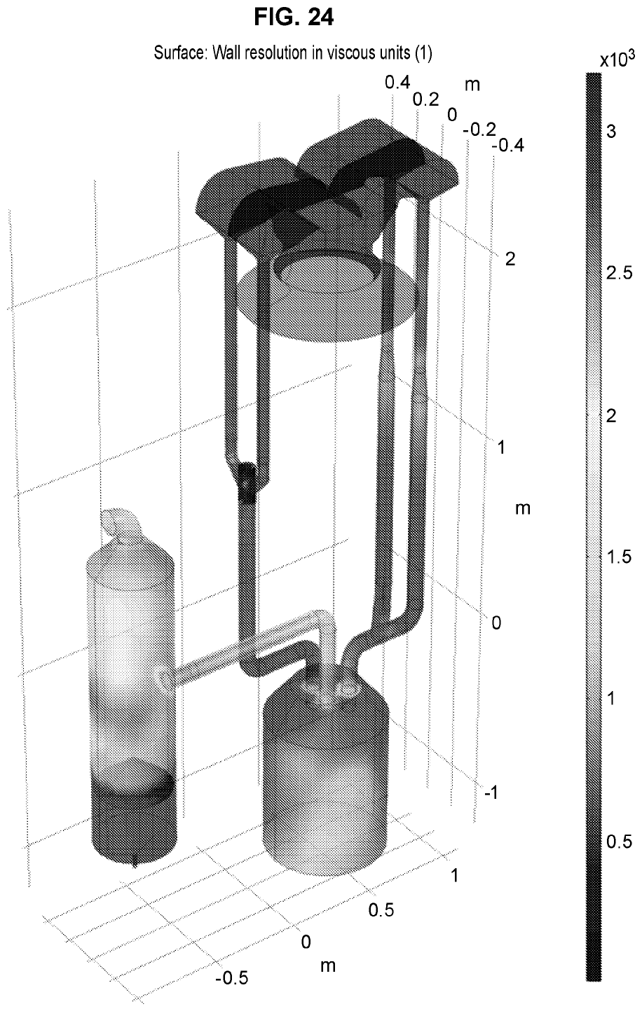

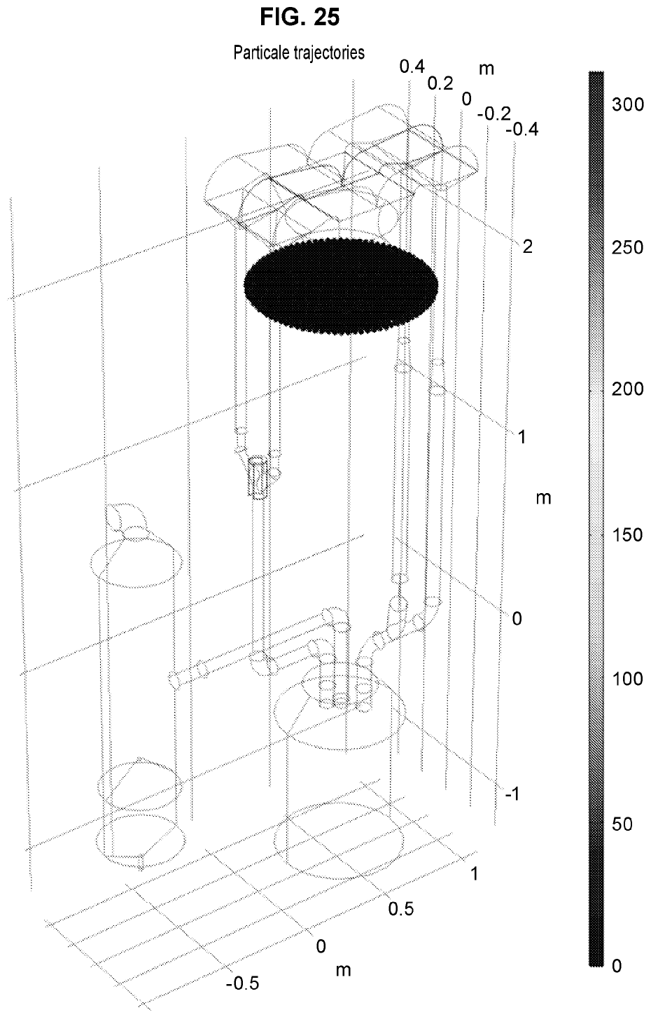

FIG. 19 is an arrow volume plot illustrating velocity fields within an example implementation. FIG. 20 is a contour plot illustrating velocity magnitudes within the example implementation. FIG. 21 is a contour plot illustrating pressure within the example implementation. FIG. 22 is a streamline plot illustrating velocity fields within the example implementation. FIG. 23 is a slice plot illustrating velocity magnitude within the example implementation. FIG. 24 is a surface plot illustrating wall resolution in viscous units for the example implementation. FIG. 25 is a plot illustrating particle trajectories within the example implementation.

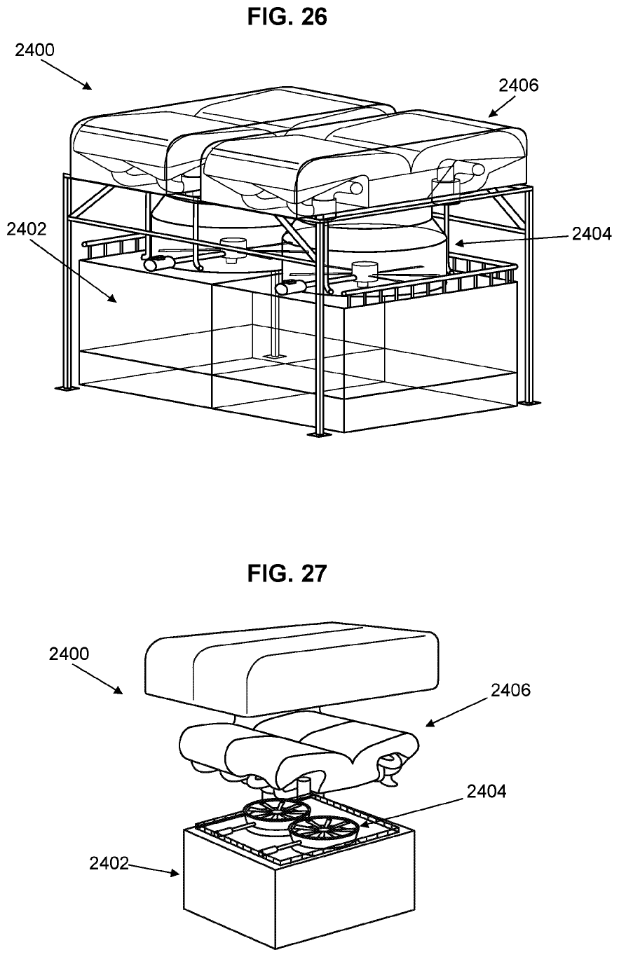

FIGS. 26-33 illustrate another example embodiment for condensing vapor product. The present system 2400 illustrated in FIGS. 26-33 is a duct system 2406 arranged above an existing cooling tower 2402 and turbine 2404 that condenses and recovers evaporating water. Using psychrometrics, the duct system 2406 splits and straightens the airflow to prevent back pressure and reduce turbulence. This airflow is then directed into an ionization and cloud chamber, where a controlled electric field causes the water molecules to coalesce and condense into larger droplets. The condensed clean water is recovered, recycled, and returned to the basin and is available for reuse in the water cooling system.

In an exemplary embodiment, the system 2400 can recover 90% of evaporative water loss, which can increase the efficiency of the cooling towers. The duct system 2406 can reduce blowdown and sewage by recycling clean, evaporated water, reducing sewage discharge and wastewater disposal. The duct system 2406 can reduce chemical treatments, by recovering and recycling water. The duct system 2406 can eliminate plume rise, which often spreads bacteria and chemicals into the atmosphere. The duct system 2406 can increase the efficiency of cooling tower system fans 2404, reducing operating costs, allowing each fan to pull with less energy. The duct system 2406 can connect to existing cooling tower systems 2402, which allows for easy installation and maintenance.

Without using heat or chemicals, the duct system 2406 condenses and recovers 90% of evaporating water and eliminates the concentration of solid and liquid impurities in the system. The duct system 2406 can only requires one day for installation and involves no moving parts, which means minimal maintenance and operating expenses. The duct system 2406 does not interfere with cooling tower operations and operates independently from existing systems. The duct system 2406 fits over the top of the cooling tower with its own steel support structure and maintains existing access points. The duct system's design improves airflow by removing moisture, straightening the air flow and creating a venturi effect, which increases airflow toward the exhaust. Since the duct system 2406 returns evaporated water to the cooling tower 2402, the concentration of impurities at the basin or sump is reduced. Depending upon the quality of the water used, this may result in fewer blowdowns or the removal of solid and liquid impurities. The combination of chemicals for treating water does not change.

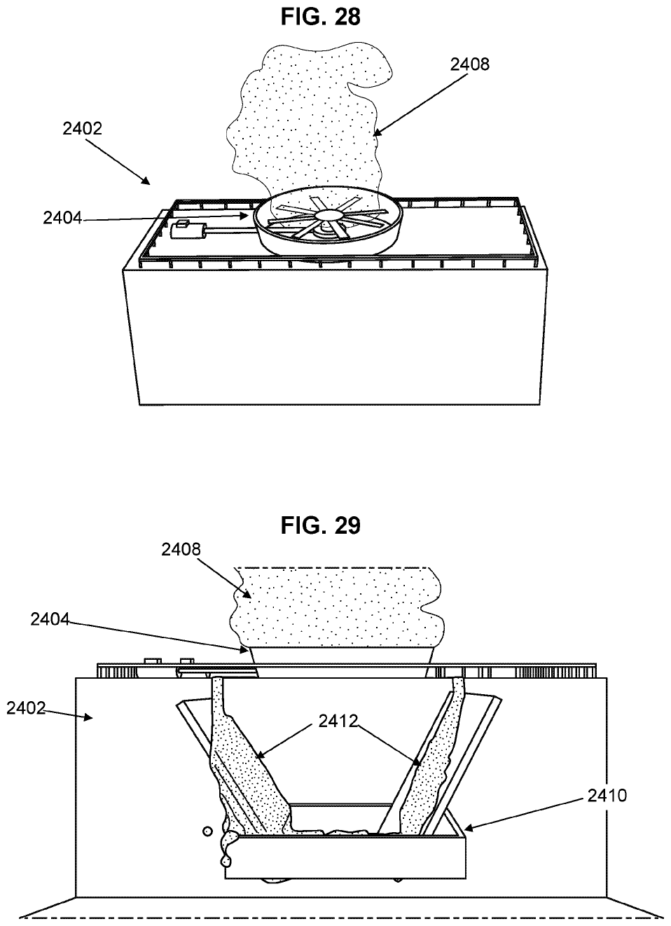

FIGS. 28-29 illustrate a cooling tower 2402 and a turbine 2404 which use water to extract waste heat and eject it into the atmosphere. In these towers 2402, humid air carries warm water vapor 2408 out of each tower 2402. Many cooling towers 2402 also utilize a sump, or basin 2410, that collects water 2412 and impurities that over time lead to corrosion and bacteria growth. Many cooling towers 2402 control these issues by adding more water and chemicals.

FIG. 30 illustrates the duct system 2406 above an existing cooling tower 2402 and turbine 2404 that condenses and recovers evaporating water 2408. The duct system 2406 splits and straightens the airflow using psychrometrics, which prevents back pressure and reduces turbulence. The duct system 2406 includes a duct 2414 and a cloud chambers 2416 for condensing the evaporating water.

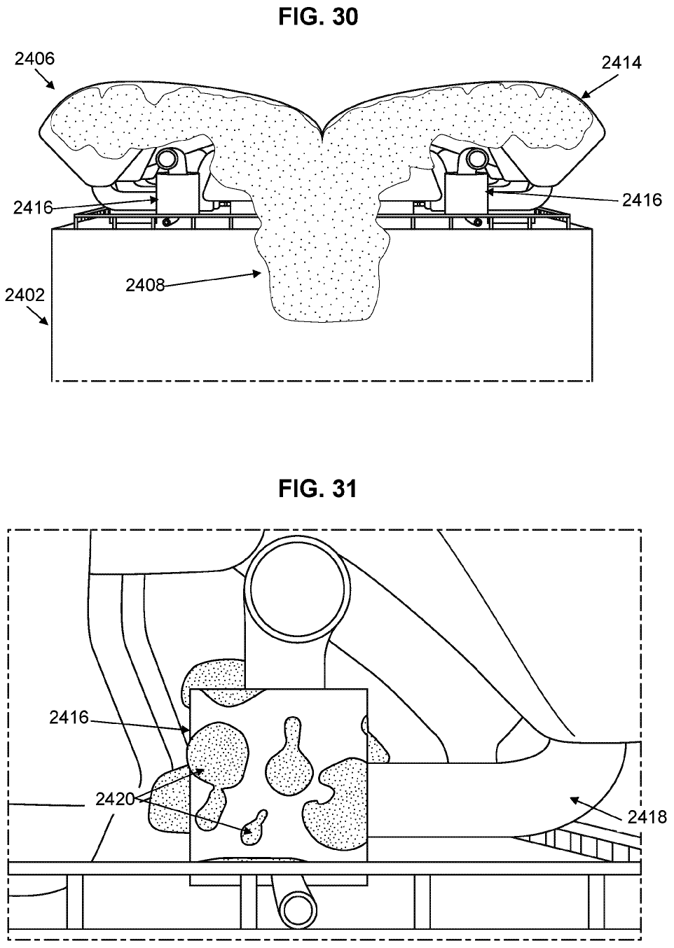

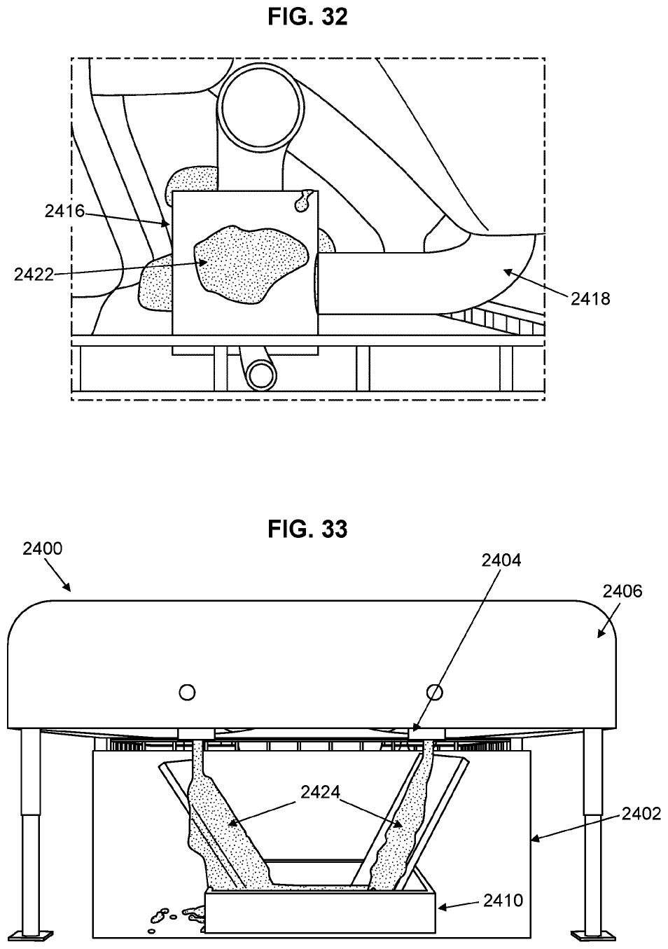

FIGS. 31-32 illustrate a cloud chamber 2416 of the duct system 2406. The duct 2414 directs the airflow 2408 to the ionization and cloud chamber 2416 through a pipe 2418, where a controlled electric field causes the water molecules 2420 to coalesce and condense into larger droplets 2422.

FIG. 33 illustrates the condensed, clean water is 2424 returning to the basin 2410. The remaining air within the system exits through an exhaust. The recovered and recycled water 2424 is now available for reuse in the water cooling system 2400.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it is used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A. B, and/or C” are each intended to mean “A alone, B alone, C alone, A and B together, A and C together, B and C together, or A and B and C together.” In addition, use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

1. A system comprising:
a first duct configured to receive a vapor product having a first humidity level, the first duct having a first charge in response to application of a first voltage to the first duct so as to ionize the vapor product;
a second duct in fluid communication with and arranged downstream of the first duct and configured to allow the ionized vapor product to pass therethrough, the second duct configured with a second charge in response to application of a second voltage that is different than the first voltage to thereby allow collection of at least a portion of liquid particles present in the ionized vapor product and form a first modified vapor product with a first modified humidity level that is greater than the first humidity level; and
a chamber configured to receive the first modified vapor product, the chamber comprising,
at least one cooling plate configured to reduce a temperature of the first modified vapor product to form a second modified vapor product having a second modified humidity level that is less than the first modified humidity level, and
at least one first mesh plate arranged downstream of the at least one cooling plate and configured to collect at least a portion of liquid particles present within the second modified vapor product or a third modified vapor product to form a fourth modified vapor product having a fourth modified humidity level that is less than at least the second modified humidity level, the at least one first mesh plate having a third charge in response to application of a third voltage that is different than the second voltage.

2. The system of claim 1, wherein the chamber further comprises a separator configured to direct liquid particles from at least the first modified vapor product and into a reservoir.

3. The system of claim 2, wherein the separator comprises a conical-shaped plate arranged within the chamber such that a gap is formed between the conical-shaped plate and a sidewall of the chamber, wherein the gap is configured to receive and direct the liquid particles into the reservoir.

4. The system of claim 1, wherein the chamber further comprises a point electrode having a fourth charge in response to application of a fourth voltage that is different than the third voltage, the point electrode configured to ionize the second modified vapor product that passes across or proximate to the point electrode to modify the electrical charge of the second modified vapor product.

5. The system of claim 1, wherein the second duct comprises a spiral electrode at least partially extending through a channel of the second duct, the spiral electrode being electrically charged with the second voltage.

6. The system of claim 5, wherein the spiral electrode comprises a plurality of point electrodes arranged along a length of the spiral electrode.

7. The system of claim 1, wherein the at least one cooling plate comprises a thermoelectric cooler.

8. The system of claim 1, wherein the chamber further includes at least one second mesh plate positioned between the point electrode and the at least one first mesh plate, the at least one second mesh plate configured to configured to collect at least a portion of liquid particles present within the second modified vapor product to form a third modified vapor product having a third modified humidity level that is less than at least the second modified humidity level.

9. The system of claim 1, wherein the at least one first mesh plate is further configured to allow the collection of the liquid particles to selectively separate from the at least one first mesh plate by at least gravity.

10. The system of claim 1, wherein the chamber further comprises a reservoir configured to receive liquid particles selectively separated from at least the first modified vapor product and the second modified vapor product.

11. The system of claim 1, further comprising a blower configured to propel the vapor product through the first duct and second duct to the chamber.

12. The system of claim 1, further comprising a reducer positioned between the first duct and the second duct and configured to increase the flow rate of the ionized vapor product as it passes through the reducer and towards the second duct.

13. A method comprising:
passing a vapor product through a first duct electrically charged with a first voltage to ionize the vapor product;
passing the ionized vapor product through a second duct positioned downstream of and in fluid communication with the first duct to form a first modified vapor product, the second duct being electrically charged with a second voltage that is different than the first voltage;
passing the first modified vapor product into a chamber, the chamber having at least one cooling plate and at least one first mesh plate positioned downstream of the at least one cooling plate, the at least one first mesh plate being electrically charged with a third voltage that is different than at least the second voltage;
cooling, by the at least one cooling plate, the first modified vapor product to form a second modified vapor product; and
removing, by the at least one first mesh plate, at least a portion of liquid particles present within the second modified vapor product or a third modified vapor product to form a fourth modified vapor product.

14. The method of claim 13, wherein the vapor product has a first humidity level, the first modified vapor product has a first modified humidity level that is greater than the first humidity level, the second modified vapor product has a second modified humidity level that is less than the first humidity level, and the fourth modified vapor product has a third humidity level that is less than the second modified humidity level.

15. The method of claim 13, wherein the chamber includes a separator positioned between an inlet of the chamber and the at least one cooling plate, and the method further comprises, prior to the removing step, separating, by the separator, at least a portion of liquid particles present within the first modified vapor product.

16. The method of claim 13, further comprising a point electrode electrically charged with a fourth voltage that is different than at least the third voltage, and the method further comprises:
ionizing, by the point electrode, the second modified vapor product that passes across or proximate to the point electrode to modify the electrical charge of the second modified vapor product.

17. The method of claim 13, wherein the chamber includes at least one second mesh plate, and the method further comprises,
removing, by the at least one second mesh plate, at least a portion of liquid particles present within the second modified vapor product to form a third modified vapor product having a third modified humidity level that is less than at least the second modified humidity level.

18. The method of claim 13, wherein a reducer is positioned between the first duct and the second duct, and wherein the method further comprises,
increasing, by the reducer, a flow rate of the ionized vapor product as it passes therethrough and towards the second duct.

19. The method of claim 13, wherein the second duct comprises a spiral electrode disposed within the second duct, the spiral electrode being electrically charged with the second voltage, and wherein passing the ionized vapor product through a second duct comprises:
passing the ionized vapor product across the spiral electrode to allow at least a portion of liquid particles present within the ionized vapor product to collect on the spiral electrode, wherein the collection of the liquid particles selectively separates from the spiral electrode such that the combination of the collection of liquid particles and the remaining ionized vapor product form the first modified vapor product.

20. The method of claim 13, further comprising:
collecting the liquid particles selectively separated from at least the first modified vapor product and the second modified vapor product and transferring the collected liquid particles to a reservoir.
